(19) United States
(12) Patent Application Publication
(10) Pub. No.: US 2013/0198372 A1
(43) Pub. Date: Aug. 1, 2013

(54) DISTRIBUTED NEWTON METHOD AND APPARATUS FOR NETWORK UTILITY MAXIMIZATION

(71) Applicant: Massachusetts Institute of Technology, Cambridge, MA (US)

(72) Inventors: Ermin Wei, Cambridge, MA (US); Asuman E. Ozdaglar-Acemoglu, Cambridge, MA (US); Ali Jadbabaie, Philadelphia, PA (US)

(73) Assignee: MASSACHUSETTS INSTITUTE OF TECHNOLOGY, Cambridge, MA (US)

(21) Appl. No.: 13/717,473

(22) Filed: Dec. 17, 2012

Related U.S. Application Data
(60) Provisional application No. 61/576,204, filed on Dec. 15, 2011.

(51) Int. Cl. H04L 12/26

(52) U.S. Cl. CPC H04L 43/10
USPC 709/224

(57) ABSTRACT

A distributed inexact Newton-type second order method for Network Utility maximization problems is provided. Such methods are capable of achieving superlinear convergence rates (in primal iterates) to some error neighborhood, can be implemented in a decentralized manner using a matrix splitting scheme, and is compatible with current information exchange mechanisms.

### CROSS REFERENCE TO RELATED APPLICATION

The present application is related to and claims benefit of priority to U.S. Provisional Patent Application No. 61/576,204 filed on Dec. 15, 2011. The content of that application is incorporated herein by reference.

### GOVERNMENT SUPPORT

This invention was made with Government support under Grant No. DMI-0545910 awarded by National Science Foundation, under Grant No. N00014-08-1-0747, awarded by the U.S. Office of Naval Research, and under Grant No. FA9550-09-1-0090 awarded by the U.S. Air Force Office of Scientific Research. The Government has certain rights in this invention.

### BACKGROUND

Most of today's communication networks are large-scale and comprise of agents with heterogeneous preferences. Lack of access to centralized information in such networks necessitates design of distributed control methods that can operate based on locally available information. Some applications include routing and congestion control in the internet, data collection and processing in sensor networks, and cross-layer design in wireless networks. Wireline networks suffer from rate control problems, which are often formulated in the Network Utility Maximization (NUM) framework. NUM problems are characterized by a fixed network and a set of sources, which send information over the network along predetermined routes. Each source has a local utility function over the rate at which it sends information. The goal is to determine the source rates that maximize the sum of utilities subject to link capacity constraints. The standard approach for solving NUM problems relies on using dual decomposition and subgradient (or first-order) methods, which through a price feedback mechanism among the sources and the links yields methods that can operate on the basis of local information. One major shortcoming of this approach is the slow rate of convergence.

### SUMMARY

A Newton-type second-order method for solving the NUM problem transforms an inequality constrained NUM problem to an equality-constrained NUM problem through introducing slack variables and logarithmic barrier functions after which an equality-constrained Newton method is used for the reformulated problem in a distributed manner, leading to significantly faster convergence. Computation of the Newton direction may, in various embodiments, be performed by an iterative scheme based on a matrix splitting technique, thereby avoiding the costs and global information requirements of matrix inversion techniques. Computation of a stepsize capable of local super linear convergence for primal iterations may, in various embodiments, be provided as inversely proportional to the inexact Newton decrement (i.e., inexactness due to errors in computation of the Newton direction), thereby avoiding the need for iterative backtracking rules.

In one aspect, at least one embodiment described herein provides a network utility maximization method for solving the NUM problem. The method includes (a) determining a price for one or more links; (b) repeating step (a) based on an error parameter and an aggregated weighed price; (c) determining a stepsize parameter based on a diagonal matrix and weighted prices; (d) determining a slack variable based on the aggregated weighted price; (e) determining a primal vector based on the aggregated weighted price, the stepsize parameter, and the slack variable; (f) repeating steps (a) through (e) based on a threshold amount and the primal vector.

In other examples, the primal vector can be indicative of optimal source rates for a destination computing device and a source computing device.

In some examples, a destination computing device can process steps (a), (b), (c), (d), (e), and (f) for source rates.

In other examples, a plurality of destination computing devices can process steps (a), (b), (c), (d), (e), and (f) for each respective source rates associated with the respective destination computing device.

In some examples, the primal vector can be determined utilizing a second-order function.

In other examples, step (a) can further include (a-1) separating routing Hessian related matrix into a plurality of parts; and (a-2) determining the link price based on the Hessian related matrix.

In some examples, step (a) can further include (a-1) receiving link price information from each link in a network route; and (a-2) determining the aggregated weighted price for the network route.

In some examples, the technology can include a computer program product tangibly embodied in an information carrier. The computer program product can include instructions being operable to cause an information processing apparatus to perform any of the steps described herein.

In other examples, the technology can include a network utility maximization system. The system can include a plurality of computing devices and each computing device can be a destination node, a source node, a link, or any combination thereof. Each computing device can include a network utility maximization function module configured to determine a price for one or more links, and repeat the determination of the price based on an error parameter and an aggregated weighed price. Each computing device can further include a stepsize parameter module configured to determine a stepsize parameter based on a diagonal matrix and weighted prices. Each computing device can further include a slack variable module configured to determine a slack variable based on the aggregated weighted price. Each computing device can further include a primal vector module configured to determine a primal vector based on the aggregated weighted price, the stepsize parameter, the slack variable, and a threshold amount.

In some examples, the primal vector can be indicative of optimal source rates for a destination computing device and a source computing device.

In other examples, the primal vector can be determined utilizing a second-order function.

In some examples, each computing device can further include a routing matrix module configured to separate a Hessian related into a plurality of parts; and determine the link price based on the Hessian related matrix.

In other examples, each computing device can further include a network link module configured to receive link price information from each link in a network route; and determine the aggregated weighted price for the network route.

The technology described herein provides various advantages over prior methods. Such advantages include, but are not limited to, reduced time to convergence and a reduced number of iterations to convergence (e.g., 20× reduction, or more). Still further advantages may include, for example, achieving positive, feasible slacks in satisfaction of link capacity constraints throughout the method.

To test the performances of the methods over general networks, 50 random networks were generated, with a number of links L=1.5 and a number of sources S=8. Each routing matrix consisted of L×R Bernoulli random variables. All three methods were implemented over the 50 networks. The number of iterations upon termination for all 3 methods was recorded and results are shown in FIG. 14 on a log scale. The mean number of iterations to convergence from the 50 trials was 924 for a distributed inexact Newton method, 20,286 for a Newton-type diagonal scaling method, and 29,315 for a subgradient method.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a diagram of an exemplary network;

FIG. 2 is a flowchart of an exemplary network utility maximization process;

FIG. 3 is a block diagram of an exemplary computing device;

FIG. 4 is a flowchart of an exemplary network utility maximization process;

FIG. 5 is a diagram of an exemplary information flow from sources to links;

FIG. 6 is a diagram of an exemplary information flow from links to sources;

FIG. 7 is a diagram of an exemplary node network;

FIGS. 8A-8B are diagrams of an exemplary auxiliary graph construction for the exemplary node network of FIG. 7;

FIGS. 9A-9C are diagrams of an exemplary evolution of a distributed summation process;

FIG. 10 is an exemplary graphical illustration of function value in a distributed inexact Newton method plotted against number of iterations;

FIG. 11 is a diagram of an additional exemplary node network;

FIG. 12 is an exemplary graphical illustration of simulation results;

FIG. 13 is an exemplary graphical illustration of additional simulation results; and

FIG. 14 is an exemplary graphical illustration of simulation results over 50 randomly generated networks.

### DETAILED DESCRIPTION

The distributed Newton network utility maximization methods and apparatuses include technology that, generally, determines optimal source rates (e.g., one megabits per second, 0.5 megabits per second, etc.) for a plurality of sources and destinations in a network (e.g., wired network, wireless network, etc.) without violating capacity constraints given predetermined routing information. The sources and/or destinations can be any type or configuration of computing devices (e.g., a computing device, a set-top cable box, a server, a video on demand server, a gaming console, a mobile device, etc.). The technology can be utilized to modify network traffic to increase the optimization of the network based on local information (e.g., route price information for the network route, processing delays along the network route, etc.) and/or local processing (e.g., each destination computing device determines optimal source rates, etc.). For example, the technology can be utilized by a video on demand server to determine an optimal source rate (e.g., one megabits per second, 0.3 megabits per second, etc.) for a video stream to a set top box. As another example, the technology can be utilized by two voice over internet protocol (VoIP) phones to determine an optimal source rate (e.g., 0.1 megabits per second, 0.25 megabits per second, etc.) for the audio stream. The technology can be utilized by network service providers, network administrators, and/or any other type of network controller to manage the network.

The technology utilizes local processes at the source computing device and/or the destination computing device to distribute the processing of the optimal source rates across a plurality of computing devices, thereby decreasing the processing time by at least a factor of two to three times. The technology improves on the standard first-order technique by using a Newton-type second-order technique to enable faster convergence to optimal source rates. The technology utilizes a transformation enabling the technology to be an equality-constrained technique, a linear technique, and/or a separable technique (e.g., the processing can be distributed across a plurality of computing devices), thereby decreasing the processing time (e.g., by a factor of two times, by a factor of ten times, etc.) required to determine optimal source rates.

The technology advantageously utilizes a Newton based distributed algorithm with a quadratic rate of convergence that decreases the time for the determination of optimal source rates. The technology advantageously splits the routing matrix to distribute the optimization process among a plurality of processors, thereby increasing the efficiency of the network optimization process by decreasing the time for determination of optimal source rates.

A Newton-type second-order method for solving the NUM problem transforms an inequality constrained NUM problem to an equality-constrained NUM problem through introducing slack variables and logarithmic barrier functions after which an equality-constrained Newton method is used for the reformulated problem in a distributed manner, leading to significantly faster convergence. Computation of the Newton direction may, in various embodiments, be performed by an iterative scheme based on a matrix splitting technique, thereby avoiding the costs and global information requirements of matrix inversion techniques. Because the objective function of the (equality-constrained) NUM problem is separable (i.e., it is the sum of functions over each of the variables) splitting, in various embodiments, allows computation of the Newton direction using decentralized methods based on limited scalar information exchange between sources and links, in a form similar to the feedback mechanism used by the subgradient methods. This exchange involves destinations iteratively sending route prices (aggregated link prices or dual variables along a route) to the sources, and sources sending the route price scaled by the corresponding Hessian element to the links along its route.

Computation of a stepsize rule that can guarantee local super linear convergence of the primal iterations is achieved by avoiding the iterative backtracking rules typically used with Newton methods. Rather, a stepsize choice which is inversely proportional to the inexact Newton decrement (where the inexactness arises due to errors in the computation of the Newton direction) is used if the decrement is above a certain threshold. Otherwise a pure Newton step is used. Also described are various distributed procedures for computing an inexact Newton decrement in a finite number of steps. Such procedures are compatible with current information exchange mechanisms because they may be accomplished using those same information exchange mechanisms. Therefore, methods having comparable levels of information exchange but requiring less time and resources are provided.

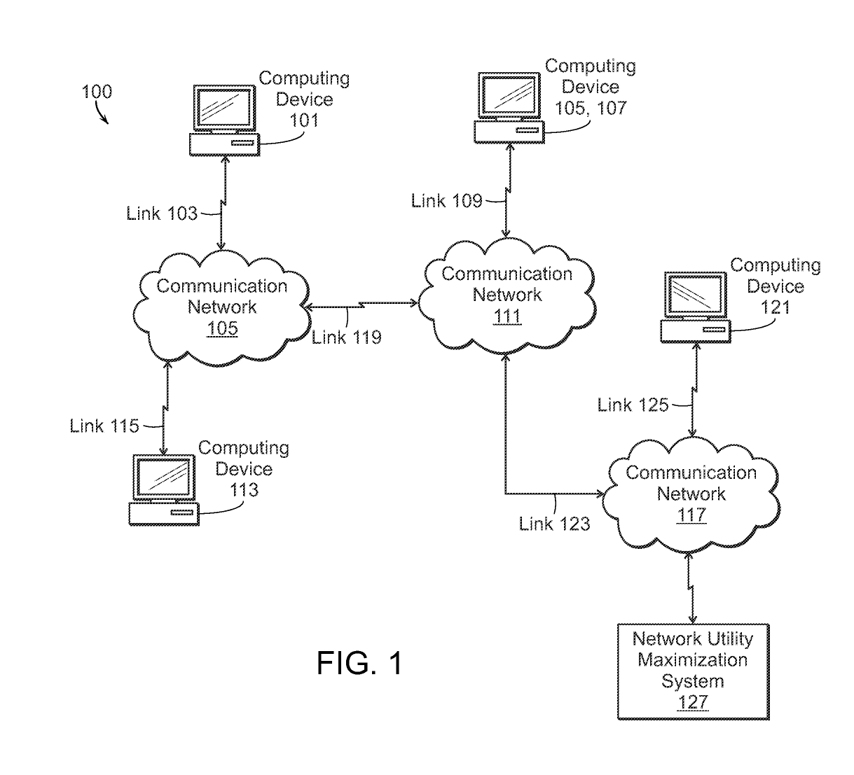

FIG. 1 is a diagram of an exemplary network 100. The network includes a plurality of computing devices 101, 105, 113, 121 (e.g., mobile device, personal computer, routing device, gateway device, set-top box, mobile device, gaming console, etc.), a plurality of communication networks 105, 111, 117 (e.g., local area network (LAN), wide area network (WAN), cable television network, satellite network, wireless network, wireless mesh network, cellular phone network, etc.), and a network utility maximization system 127. The computing devices are interconnected via a plurality of links 103, 109, 115, 119, 123, 125 and the plurality of communication networks 105, 111, 117. Each link 103, 109, 115, 119, 123, 125 has a nonnegative source rate (e.g., 1.544 megabits per second, 1000 megabits per second, etc.). The computing devices can be sources and/or destinations of communication. For example, the computing device 101 is a source of communication and computing device 113 is a destination of the communication.

The computing device 101, 105, 113, 121 (e.g., acting as the destination of the network route, the network utility maximization system 127, etc.) can determine one source rate based on a routing matrix and a network utility maximization function. Table 1 illustrates an exemplary routing matrix. The routing matrix can be utilized by the computing device 101, 105, 113, 121 to determine capacity for the links 103, 109, 115, 119, 123, 125. For each pair of source and destination, Table 1 illustrates the links 103, 109, 115, 119, 123, 125 utilized for a network route. In some examples, a source and destination pair can have a plurality of available network routes. In other examples, each computing device 101, 105, 113, 121 receives the network route information for the network routes associated with the computing device 101, 105, 113, 121 (e.g., destination, source, link, etc.). In other words, each computing device receives and/or stores the parts of the routing matrix related to the network routes that start, end, and/or go through the respective computing device 101, 105, 113, 121. Table 2 illustrates another exemplary routing matrix with a weight (e.g., 0, 1, 50, 100, etc.) indicating whether the link 103, 109, 115, 119, 123, 125 is utilized for the source. The exemplary routing matrix illustrated in Table 2 is a subset of the sources and destinations pairs for the computing devices 101, 105, 113, 121. The computing device 101, 105, 113, 121 can utilize a routing matrix that includes the source and destination iterations of the computing devices 101, 105, 113, 121.

TABLE 1
Exemplary Routing Matrix

| | | Source | | | |
|---|---|---|---|---|---|
| | | Computing | Computing | Computing | Computing |
| | | Device 101 | Device 105 | Device 113 | Device 121 |
| Destination | Computing | — | Links 109, | Links 115 | Links 125, |
| | Device 101 | | 119, and | and 103 | 123, 119, |
| | | | 103 | | and 103 |
| | Computing | Links 103, | — | Links 115, | Links 125, |
| | Device 105 | 119, and | | 119, and | 123, and |
| | | 109 | | 109 | 109 |
| | Computing | Links 103 | Links 109, | — | Links 125, |
| | Device 113 | and 115 | 119, and | | 123, 119, |
| | | | 115 | | and 115 |
| | Computing | Links 103, | Links 109, | Links 115, | — |
| | Device 121 | 119, 123, | 123, and | 119, 123, | |
| | | and 125 | 125 | and 125 | |

TABLE 2
Exemplary Routing Matrix

| | Source = | Source = |
|---|---|---|
| | Computing Device 101; | Computing Device 103; |
| | Destination = | Destination = |
| | Computing Device 113 | Computing Device 121 |
| Link 103 | 1 | 0 |
| Link 109 | 0 | 1 |
| Link 115 | 1 | 0 |
| Link 119 | 0 | 0 |
| Link 123 | 0 | 1 |
| Link 125 | 0 | 1 |

The computing device 101, 105, 113, 121 can initialize the network utility maximization function 127 (e.g., equation 6 below). In some examples, each computing device 101, 105, 113, 121, acting as a source, transmits information for each of the routes to the links 103, 109, 115, 119, 123, 125 along a particular route. Each link 103, 109, 115, 119, 123, 125 can include the link price (e.g., four millisecond travel time, five hundred millisecond delay due to processing, etc.) for transmission along the route and transmits the link price to the destination. In some examples, each link 103, 109, 115, 119, 123, 125 is a computing device 101, 105, 113, 121 (e.g., gateway, router, computing device in a wireless mesh network, etc.).

The computing device, acting as a destination, can determine the weighted price and transmit the weighted price (e.g., ten milliseconds, twenty milliseconds, etc.) for the network route to the links along the network route. The weighted price can be the total price (e.g., delay, latency, etc.) for utilizing a specific network route. In other words, each link along a network route (e.g., 103, 109, 115, 119, 123, 125) can transmit the link price for transmission along the route, which enables the destination computing device 101, 105, 113, 121 to determine the aggregated cost for utilizing the link in the network route.

The computing device 101, 105, 113, 121 starts an iterative Newton type process. The iterative Newton type process can include separating a routing matrix (e.g., Hessian matrix as described below, Hessian matrix, routing matrix, Table 1, Table 2, etc.) into a plurality of parts. Each part of the routing matrix can be processed by a computing device, acting as the source and/or the destination, to determine a diagonal matrix for the network source rates. The diagonal matrix can be utilized to compute the Newton direction for the process. The distributed computing of the diagonal matrix across the destination computing devices advantageously decreases the processing time (e.g., by a factor of three, by a factor of twenty, decrease by ten seconds, etc.) for the process by decentralizing the matrix processing.

The iterative Newton type process can include a dual iteration process (e.g., equation 17 below) and can be processed by a computing device, acting as the source, the destination, and/or links. The dual iteration process can enable the source and the destination for each network route to determine updated link prices for the network source rates. The dual iteration process includes receiving link price information (e.g., delay time, capacity information, etc.) from the links (i.e., computing devices associated with each link add the link price information), aggregating the link prices from all of the links (e.g., four hundred millisecond transmission time, one second delay in transmission, etc.), and transmitting the aggregated weighted price to the links. The dual iteration process is distributed among the computing devices so that each source and destination pair determines the aggregated weighted price for the respective network source rate, thereby decreasing the processing load on any one computing device and decreasing the time required to determine an optimized network source rates.

The computing device 101, 105, 113, 121 can continue the dual iteration process until an error condition is satisfied and/or a number of iterations are completed (e.g., as described below). The dual iteration process can enable the source and destination pairs to determine an optimal weighted price for a particular network route, thereby distributing the processing among the computing devices 101, 105, 113, 121 and decreasing the time required to determine an optimized network source rates.

For example, destination computing devices 101, 105, 113, 121 process ten iterations of the dual iteration process and the aggregated weighted price between the ninth and the tenth iteration changes less than 1%. The dual iteration process is repeated five more times because the change between the last two iterations has to be less than 0.5%. After the repeat of the dual iteration process five more times, the destination computing device 101, 105, 113, 121 checks the change of the aggregated weighted price between the fourteenth and fifteenth iterations. The change in the aggregated weighted price between the fourteenth and fifteenth iterations is 0.4% and the dual iteration process ends.

The computing device 101, 105, 113, 121 can determine a stepsize parameter completed (e.g., as described below) based on the link weights and/or the diagonal matrix for the network route. The stepsize parameter (e.g., adjustment of five milliseconds, decrease in weight for use of a preferred link, etc.) can be utilized to compute a Newton decrement for the network optimization procedure. The stepsize parameter is indicative of the local aggregated price differences for utilizing a particular link. The determination of the stepsize parameter can be processed by each of the sources and/or destinations, thereby decreasing the time to determine an optimized network route.

The computing device 101, 105, 113, 121 can determine slack variables for each link based on the weight price for the respective link (e.g., equation 27 below). The slack variables for each link can be indicative of the available capacity of the link (e.g., 90% available capacity, 70% of the time capacity is below 50% capacity, etc.). In some examples, the computing device, acting as the link, determines the slack variable for each link.

The computing device 101, 105, 113, 121 can generate a primal vector for each network route based on the aggregated weighted price, the stepsize parameter, and the slack variables (e.g., equation 28 below). The primal vector for each source and destination pair can be the optimized network source rates for the respective pair (e.g., links A, B, and C; links D, E through F; etc.).

The computing device 101, 105, 113, 121 can determine an error in the primal vector (e.g., equation 30 below) to ensure that the error in the process is less than a threshold amount (e.g., less than 1% variance between initial network route and optimized network route, aggregated weighted price is less than five milliseconds, etc.). If the error in the primal vector is not less than a threshold amount, the dual iteration process is repeated. The repeating of the dual iteration process enables the error in the primal vector to be decreased while minimizing processing time, thereby providing near-optimal source rates in a minimum time.

Although the process described herein is described utilizing the computing device 101, 105, 113, 121, the process can be distributed across any number and/or type of system and/or module. For example, the computing device that acts as the destination for each network route can execute the process, as described herein, for the optimal source rates associated with the destination.

Although FIG. 1 illustrates the network utility maximization system 127, the optimal source rates can be determined by a centralized network utility maximization system 127, a plurality of network utility maximization systems 127, and/or each respective source and destination pair for a network route. In other words, the network utility maximization process can be processed by any of the computing devices 101, 105, 113, 121, acting as a source, a destination, and/or a link, thereby distributing the network utility maximization process 127 across a plurality of computing devices 101, 105, 113, 121 and decreasing the time required to determine optimal source rates. In some examples, all or part of the techniques, as described herein, is processed by a computing device 101, 105, 113, 121, acting as a destination, for each of the network routes. The computing devices 101, 105, 113, 121 illustrated in FIG. 1 can be endpoint devices (e.g., set-top box, personal computer, etc.) and/or gateways to other networks (e.g., router for a local area network (LAN), a gateway for a world-wide private network, etc.).

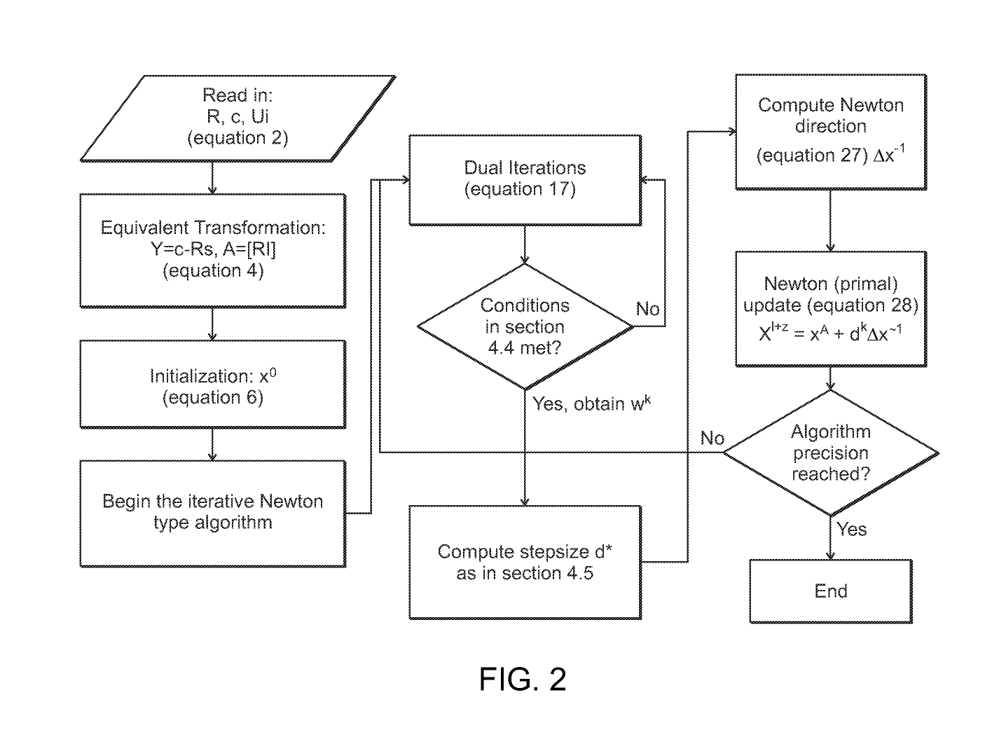

FIG. 2 is a flowchart of an exemplary network utility maximization process utilizing, for example, the equations and/or processes described below.

In the following analyses, a vector is viewed as a column vector, unless clearly stated otherwise. [symbol] ₊ to denotes the set of nonnegative real numbers, i.e., [symbol] ₊=[0, ∞). Subscripts denote the components of a vector and superscripts to index a sequence, i.e., xᵢ is the i^{th} component of vector x and x^{k} is the k^{th} element of a sequence. When xᵢ≧0 for all components i of a vector x, write x≧0.

For a matrix A in the following analyses, the expression Aᵢⱼ is used to denote the matrix entry in the i^{th} row and the j^{th} column, and [A]ᵢ to denote the i^{th} column of the matrix A, and [A]ⱼ to denote the row of the matrix A. I(n) is used to denote the identity matrix of dimension n×n and x′ and A′ are used to denote the transpose of a vector x and a matrix A respectively. For a real-valued function ƒ:X→ [symbol] where X is a subset of [symbol] ⁿ, the gradient vector and the Hessian matrix of ƒ at x in X are denoted by ∇ƒ(x) and ∇²F(x) respectively. Vector e is used to denote a vector of all ones.

In the following analyses, a real-valued convex function g:X→ [symbol] , where X is a subset of [symbol] , is self-concordant if it is three times continuously differentiable and |g′″(x)|≦2g″(x)^{3/2} For real-valued functions in [symbol] ⁿ, a convex function ƒ:X→ [symbol] , where X is a subset of [symbol] ⁿ, is self-concordant if it is self-concordant along every direction in its domain, i.e., if the function \tilde{g}(t)=g(x+tv) is self-concordant in t for all x and v. Operations that preserve the self-concordance property include summing, scaling by a factor a≧1, and composition with affine transformation.

### Network Utility Maximization Problem

In accordance with various embodiments, a network represented by a set L={1, . . . , L} of (directed) links of finite nonzero capacity given by c=[c₁]_{l∈L} with c>0 may be used. Such networks may also be shared by a set S={1, . . . , S} of sources, each of which transmits information along a predetermined route. For each link l, let S(l) denote the set of sources use it. For each source i, let L(i) denote the set of links it uses. The nonnegative source rate vector is denoted by s=[s₁]_{l∈L}. A capacity constraint at the links can be compactly expressed as Rs≦c, where R is the routing matrix of dimension L×S, i.e.,

$${R}_{ij} = \{ \begin{matrix}1 & if link i is on the route of source j , \\ 0 & otherwise .\end{matrix}$$

A utility function Uᵢ: [symbol] ₊→ [symbol] is associated with each source i, i.e., Ui(Si) denotes the utility of source i as a function of the source rate Si. Assuming the utility functions are additive, such that the overall utility of the network is given by Σᵢ₌₁^{S} Uᵢ(sᵢ), Network Utility Maximization(Num) problem can formulated as

$$maximize {\sum }_{i = 1}^{S} {U}_{i} ( {s}_{i} ) \\ subject to Rs \leq c , s \geq 0. \qquad ( 2 )$$

In various embodiments, the following assumption may be used for convergence analysis:

Assumption 1:

The utility functions Uᵢ: [symbol] ₊→ [symbol] are strictly concave, monotonically non-decreasing on (0,∞). The functions −Uᵢ: [symbol] ₊→ [symbol] are self-concordant on (0,∞).

A related equality-constrained problem facilitates the development of a distributed Newton-type method by introducing nonnegative slack variables [yₗ]_{l∈L} for capacity constraints, defined by

$${\sum }_{j = 1}^{S} {R}_{lj} {s}_{j} + {y}_{l} = {c}_{l} for l = 1 , 2 … L ,$$

and logarithmic barrier functions for the non-negativity constraints (which can be done since the feasible set of (2) has a nonempty interior). The new decision vector is denoted by x=([sᵢ]′_{i∈S}, ┌yₗ┐′_{l∈L})′. This problem can be written as

$$minimize - {\sum }_{i = 1}^{S} {U}_{i} ( {x}_{i} ) - μ {\sum }_{i = 1}^{S + L} log ( {x}_{i} ) \\ subject to Ax = c , \qquad ( 4 )$$

where A is the L×(S+L)-dimensional matrix given by

A=[R I(L)|,

and μ is a nonnegative barrier function coefficient. ƒ(x) is used to denote the objective function of problem (4), i.e., ƒ(x)=−Σᵢ₌₁^{S}Uᵢ(xᵢ)−μΣᵢ₌₁^{S+L} log(xᵢ), and ∫* to denote the optimal value of this problem.

By Assumption 1, the function ƒ(x) is separable, strictly convex, and has a positive definite diagonal Hessian matrix on the positive orthant. Throughout the following analyses, it is assumed that μ>1. which guarantees that ƒ(x) is self-concordant, since both summing and scaling by a factor, μ≧1 preserve self-concordance property. This is without loss of generality because, under self-concordance assumptions, the :problem with a general μ≧0 can be addressed by solving two instances of problem (4) with different coefficients μ≧1.

### Exact Newton Method

For each fixed μ≧1, problem (4) is feasible and has a convex objective function, affine constraints, and a finite optimal value ƒ⁶. Therefore, a strong duality theorem may be used to show that, for problem (4), there is no duality gap and there exists a dual optimal solution (see [4]). Moreover, since matrix A has full row rank, a (feasible start) equality-constrained Newton method can be used to solve problem (4). In the iterative methodology described herein, x^{k} is used to denote the primal vector at the k^{th} iteration.

### Feasible Initialization

The method may be initiated with some feasible and strictly positive vector x⁰. For example, one such initial vector is given by

$${x}_{i}^{0} = \frac{\underline{c}}{S + 1} for i = 1 , 2 … S , \\ {x}_{i + s}^{0} = {c}_{l} - {\sum }_{j = 1}^{S} {R}_{ij} \frac{\underline{c}}{S + 1} for l = 1 , 2 … L , \qquad ( 6 )$$

where c₁ is the finite capacity for link l, c is the minimum (positive) link capacity, S is the total number of sources in the network, and R is routing matrix [of. Eq. (1)].

### Iterative Update Rule

Given an initial feasible vector x⁰, the method generates the iterates by

x^{k+1}=x^{k}+d^{k}Δx^{k}, (7)

where d^{k} is a positive stepsize, Δx^{k} is the (primal) Newton direction given as the solution of the following system of linear equations:

$$( \begin{matrix}{∇}^{2} f ( {x}^{k} ) & {A}^{′} \\ A & 0\end{matrix} ) ( \begin{matrix}Δ {x}^{k} \\ {w}^{k}\end{matrix} ) = - ( \begin{matrix}∇ f ( {x}^{k} ) \\ 0\end{matrix} ) . \qquad ( 8 )$$

x^{k} is referred to herein as the primal vector and w^{k} is referred to herein as the dual vector (and their components as primal and dual variables respectively). w^{k} is also referred to as the price vector since the dual variables ┌wₗ^{k}┐_{l∈L} associated with the link capacity constraints can be viewed as prices for using links. For notational convenience, Hₖ=∇²ƒ(x^{k}) is used to denote the Hessian matrix throughout the analyses that follow.

Solving for Δx^{k} and w^{k} in the preceding system yields

Δx^{k}=−Hₖ⁻¹(∇ƒ(x^{k})+A′w^{k}), (9)

(ΔHₖ⁻¹A′)w^{k}=−AHₖ⁻¹∇ƒ(x^{k}). (10)

The system has a unique solution for all k. Note that the matrix Hₖ is a diagonal matrix with entries

$${( {H}_{k} )}_{ii} = \{ \begin{matrix}- \frac{{\partial }^{2} {U}_{i} ( {x}_{i}^{k} )}{\partial {x}_{i}^{2}} + \frac{μ}{{( {x}_{i}^{k} )}^{2}} & 1 \leq i \leq S , \\ \frac{μ}{{( {x}_{i}^{k} )}^{2}} & S + 1 \leq i \leq S + L .\end{matrix} \qquad ( 11 )$$

By Assumption 1, the functions Uᵢ are strictly concave, which implies

$$\frac{{\partial }^{2} {U}_{i} ( {x}_{i}^{k} )}{\partial {x}_{i}^{2}} \leq 0.$$

Moreover, the primal vector x^{k} is bounded (since the method maintains feasibility) and, as described with reference to the stepsize function, can be guaranteed to remain strictly positive by proper choice of stepsize. Therefore, the entries (Hₖ)ᵢᵢ>0 are well-defined for all i, implying that the Hessian matrix Hₖ is invertible. Due to the structure A[cf., Eq. (5)], the column span of A is the entire space [symbol] ^{L}, and hence the matrix AHₖ⁻¹A′ is also invertible. This shows that the preceding system of linear equations can be solved uniquely for all k.

The objective functions ƒ is separable in xᵢ, therefore given the vector wₗ^{k} for l in L(i), the Newton direction Δxᵢ^{k} can be computed by each source i using local information available to the source. However, the computation of the vector w^{k} at a given primal solution x^{k} cannot be implemented in a decentralized manner since the evaluation of the matrix inverse (AHₖ′A′)⁻¹ requires global information. The following section provides a distributed inexact Newton method, based on computing the vector w^{k} using a decentralized iterative scheme.

### Distributed Inexact Newton Method

Matrix splitting can be used to solve a system of linear equations given by

Gy=a,

where G is an n×n matrix and a is an n-dimensional vector. Suppose that the matrix G can be expressed as the sum of an invertible matrix M and a matrix N, i.e.,

G=M+N. (12)

Let y₀ be arbitrary n-dimensional vector. A sequence {y^{k}} can be generated by the following iteration:

y^{k+1}=−M⁻¹Ny^{k}+M⁻¹a. (13)

It can be seen that the sequence {y^{k}} converges as k→∞ if and only if the spectral radius of the matrix M⁻¹N is strictly bounded above by 1. When the sequence {y^{k}} converges, its limit y* solves the original linear system, i.e., Gy*=a. Hence, the key to solving the linear equation via matrix splitting is the bound on the spectral radius of the matrix M⁻¹N. Such a bound can be obtained using the following result:

### Theorem 4.1:

Let G be a real symmetric matrix. Let M and N be matrices such that G=M+N and assume that M is invertible and both matrices M+N and M−N are positive definite. Then the spectral radius of M⁻¹N, denoted by ρ(M⁻¹N), satisfies ρ(M⁻¹N)<1.

By the above theorem, if G is a real, symmetric, positive definite matrix and M is a nonsingular matrix, them one sufficient condition for the iteration (13) to converge is that the matrix M−N is positive definite. This can be guaranteed using Gershgorin Circle Theorem:

### Theorem 4.2 (Gershgorin Circle Theorem):

Let G be an n×n matrix, and define rᵢ(G)=Σ_{j≠i}|Gᵢⱼ|. Then, each eigenvalue of G lies in one of the Gershgorin sets {Γᵢ}, with Γᵢ defined as disks in the complex plane, i.e.,

Γᵢ={z∈ [symbol] ∥z−Gᵢᵢ|≦rᵢ(G)}.

One corollary of the above theorem is that if a matrix G is strictly diagonally dominant, i.e., |Gᵢᵢ|>Σ_{j≠i}|Gᵢⱼ|, and Gᵢᵢ>0 for all i, then the real parts of all the eigenvalues lie in the positive half of the real line, and thus the matrix is positive definite. Hence a sufficient condition for the matrix M−N to be positive definite is that M−N is strictly diagonally dominant with strictly positive diagonal entries.

### Distributed Computation of the Dual Vector

The matrix splitting scheme described above compute the dual vector w^{k} in Eq. (10) is used in a distributed manner for each primal iteration k. For notational convenience the explicit dependence of w^{k} on k may be suppressed. Let Dₖ be diagonal matrix, with diagonal entries

(Dₖ)ₐ=(AH⁻¹A′)ₐ, (14)

and matrix Bₖ be given by

Bₖ=AHₖ⁻¹A′−Dₖ. (15)

Let matrix B̅ₖ be a diagonal matrix, with diagonal entries

$${( {\overline{B}}_{k} )}_{ii} = {\sum }_{j = 1}^{L} {( {B}_{k} )}_{ij} . \qquad ( 16 )$$

By splitting the matrix AHₖ⁻¹A′ as sum of Dₖ+Bₖ and Bₖ− B̅ₖ, the following result may be achieved:

### Theorem 4.3:

For a given k>0, let Dₖ, Bₖ, B̅ₖ be the matrices defined in Eqs. (14), (15) and (16). Let w(0) be an arbitrary initial vector and consider the sequence {w(l)} generated by the iteration

w(t+1)=(Dₖ+ B̅ₖ)⁻¹( B̅ₖ−Bₖ)w(t)(Dₖ+ B̅ₖ)⁻¹(−AHₖ⁻¹∇ƒ(x^{k})), (17)

for all t≧0. Then the spectral radius of the matrix (Dₖ+ B̅ₖ)⁻¹(Bₖ− B̅ₖ), is strictly bounded above by 1 and the sequence {w(t)} converges as t→∞, and its limit is the solution to Eq. (10).

Splitting the matrix AHₖ⁻¹A′ may be accomplished using

(AHₖ⁻¹A′)=(Dₖ+ B̅ₖ)+(Bₖ− B̅ₖ) (18)

and the iterative scheme presented in Eqs. (12) and (13) to solve Eq. (10). For all k, both the real matrix Hₖ and its inverse, Hₖ⁻¹ are positive definite and diagonal. The matrix A has full row rank and is element-wise non-negative. Therefore the product AHₖ⁻¹A′ is real, symmetric, element-wise non-negative and positive definite. Let

Qₖ=(Dₖ+ B̅ₖ)−(Bₖ− B̅ₖ)=Dₖ+2 B̅ₖ−Bₖ (19)

denote the difference matrix. By definition of Bₖ [cf. Eq. (16)], the matrix 2 B̅ₖ−Bₖ is diagonally dominant, with non-negative diagonal entries. Moreover, due to strict positivity of the second derivatives of the logarithmic barrier functions, (Dₖ)ₛᵢ>0 for all i. Therefore, the matrix Qₖ is strictly diagonally dominant. By Theorem 4.2 such matrices are positive definite. Therefore, by Theorem 4.1 the spectral radius of the matrix (Dₖ+ B̅ₖ)⁻¹(Bₖ− B̅ₖ) is strictly bounded above by 1. Hence, the splitting scheme (18) guarantees the sequence {w(t)} generated by iteration (17) to converge to the solution of Eq. (10).

This provides an iterative scheme to compute the dual vector w^{k} at each primal iteration k using an iterative scheme. The iterative scheme defined in Eq. (17) is referred to herein as the dual iteration.

There are many ways to split the matrix AHₖ⁻¹A′ and any such methodologies are acceptable. However, the particular methodology in Eq. (18) is chosen here for two desirable features. First, it guarantees that the difference matrix Qₖ [cf. Eq. (19)] is strictly diagonally dominant, and hence ensures convergence of the sequence {w(t)}. Second, with this splitting scheme the matrix Dₖ+ B̅ₖ is diagonal, which eliminates the need for global information when calculating its inverse.

Iteration (17) is then rewritten, the information exchange required to implement it analyzed, and a distributed computation procedure to calculate the dual vector developed. For notational convenience, define the price of the route for source i, πᵢ(t), as the sum of the dual variable associated with links used by source i at the t^{th} dual iteration, i.e., πᵢ(t)=Σ_{l∈L(i)}wₗ(t). Similarly, define the weighted price of the route for source i, Πᵢ(t, as the price of the route for source i weighted by the ith diagonal element of the inverse Hessian matrix, i.e., πᵢ(t)=Σ_{l∈L(i)}wᵢ(t).

### Lemma 4.4.

For each primal iteration k, the dual iteration (17) can be written as

$${w}_{i} ( t + 1 ) = \frac{1}{{( {H}_{k} )}_{( S + l ) ( S + i )}^{- 1} + {\sum }_{i ∈ S ( l )} {Π}_{i} ( 0 )} ( ( {\sum }_{i ∈ S ( l )} {Π}_{i} ( 0 ) - {\sum }_{i ∈ S ( l )} {( {H}_{k} )}_{ii}^{- 1} ) {w}_{l} ( t ) - {\sum }_{i ∈ S ( l )} {Π}_{i} ( t ) + {\sum }_{i ∈ S ( l )} {( {H}_{k} )}_{ii}^{- 1} {w}_{i} ( t ) - {\sum }_{i ∈ S ( l )} {( {H}_{k} )}_{ii}^{- 1} {∇}_{i} f ( {x}^{k} ) - {( {H}_{k}^{- 1} )}_{( S + l ) ( S + i )} {∇}_{S + l} f ( {x}^{k} ) ) . \qquad ( 20 )$$

where Πᵢ(0) is the weighted price of the route for source i when w(0)==[1, 1 . . . 1]′.

Recall the definition of matrix A, i.e.,

Aₗ i.e., Aₗᵢ=1 for i=1, 2 . . . S if source i uses link l,
i.e., i∈S(l), and Aᵢₛ=0 otherwise. Therefore, the price of the route for source i can be expressed as, πᵢ(l)=Σₗ₌₁^{L}Aₗᵢw(l)ₗ=[A′]ⁱw(l). Similarly, since the Hessian matrix Hₖ is diagonal, the weighted price can be written as

Hᵢ(l)=(Hₖ)ᵢᵢ⁻¹[A′]w(l)=[Hₖ⁻¹A′]ⁱw(l). (21)

On the other hand, since A−[R I(L)], where R is the routing matrix, we have

$$\begin{matrix}\text{?} = {\sum }_{i = 1}^{S} ( {\vert A \vert}_{i} \text{?} + {( {H}_{k}^{- 1} )}_{( S + l ) ( S + i )} {w}_{l} ( t ) \\ = {\sum }_{i = 1}^{S} \text{?} + {( {H}_{k}^{- 1} )}_{( S + l ) ( S + i )} {w}_{l} ( t ) .\end{matrix}$$

$$\text{?} \text{indicates text missing or illegible when filed}$$

Using the definition of the matrix A one more time, this implies

$$\begin{matrix}\text{?} = {\sum }_{i ∈ S ( l )} \text{?} w ( t ) + {( {H}_{k}^{- 1} )}_{( S + l ) ( S + i )} {w}_{l} ( t ) \\ = {\sum }_{i ∈ S ( l )} {Π}_{i} ( t ) + {( {H}_{k}^{- 1} )}_{( S + l ) ( S + i )} {w}_{l} ( t ) ,\end{matrix} \\ \text{?} \text{indicates text missing or illegible when filed} \qquad ( 22 )$$

where the last equality follows from Eq. (21).
Using Eq. (15), the above relation implies that:

((Bₖ+Dₖ)w(t))ₗ=Σ_{i∈S(l)}Πᵢ(t)+(Hₖ⁻¹)_{(S+l)(S+l)}wₗ(t).

Next, ( B̅ₖ)ᵤ is rewritten. Using the fact that w(0)=[1, 1 . . . , 1]′, we have

$$\text{?} = {( ( {B}_{k} + {D}_{k} ) w ( 0 ) )}_{l} = {\sum }_{j = 1}^{L} {( {B}_{k} )}_{ij} + ( {D}_{k} ) \text{?} . \\ \text{?} \text{indicates text missing or illegible when filed}$$

Using the definition of B̅ₖ [cf. Eq. (16)], this implies

$$( {B}_{k} ) \text{?} = {\sum }_{j = 1}^{L} {( {B}_{k} )}_{ij} = ( {AH}_{k}^{- 1} {A}^{′} w ( 0 ) ) \text{?} - ( {D}_{k} ) \text{?} = {\sum }_{i ∈ S ( l )} {Π}_{i} ( 0 ) + {( {H}_{k}^{- 1} )}_{( S + l ) ( S + i )} - ( {D}_{k} ) \text{?} . \\ \text{?} \text{indicates text missing or illegible when filed}$$

This calculation can further be simplified using

$$( {D}_{k} ) \text{?} = ( {AH}_{k}^{- 1} {A}^{′} ) \text{?} = {\sum }_{i ∈ S ( l )} {( {H}_{k} )}_{ii}^{- 1} + {( {H}_{k} )}_{( S + l ) ( S + i )}^{- 1} , \\ \text{?} \text{indicates text missing or illegible when filed} \qquad ( 23 )$$

[cf. Eq. (14)], yielding

$$( {\overline{B}}_{k} ) \text{?} = {\sum }_{i ∈ S ( l )} \text{?} ( 0 ) - {\sum }_{i ∈ S ( l )} {( {H}_{k} )}_{ii}^{- 1} . \\ \text{?} \text{indicates text missing or illegible when filed} \qquad ( 24 )$$

Following the same argument, the value (Bₖw(l)))ₜ for all t can be written as

$$\begin{matrix}( {B}_{k} w ( t ) ) \text{?} = ( {AH}_{k}^{- 1} {A}^{′} w ( t ) ) \text{?} - {( {D}_{k} w ( t ) )}_{i} \\ = {\sum }_{i = 1}^{S} {Π}_{i} ( t ) + {( {H}_{k}^{- 1} )}_{( S + l ) ( S + i )} {w}_{i} ( t ) - \\ ( {D}_{k} ) \text{?} {w}_{l} ( t ) \\ = {\sum }_{i = 1}^{S} {Π}_{i} ( t ) + {\sum }_{i ∈ S ( l )} {( {H}_{k} )}^{- 1} {w}_{i} ( t ) .\end{matrix}$$

$$\text{?} \text{indicates text missing or illegible when filed}$$

where the first equality follows from Eq. (16), the second equality follows from Eq. (22), and the last equality follows from Eq. (23).

Finally, (AHₖ⁻¹∇ƒ(x^{k})) can be expressed as:

$${( {AH}_{k}^{- 1} ∇ f ( {x}^{k} ) )}_{l} = {\sum }_{i ∈ S ( l )} {( {H}_{k}^{- 1} )}_{ii} {∇}_{i} f ( {x}^{k} ) + {( {H}_{k}^{- 1} )}_{( S + l ) ( S + i )} {∇}_{S + l} f ( {x}^{k} ) .$$

Substituting the preceding into (17), the desired iteration (20) is obtained.

Next, the information exchange required to implement iteration (20) among sources and links in the network is analyzed. First, the local information available to sources and links is observed. Each source i knows the ith diagonal entry of Hessian (Hₖ)ᵢᵢ and the ith component of the gradient ∇ᵢ∫(x^{k}). Similarly, each link l knows the (S+l)th diagonal entry of the Hessian (Hₖ)_{S+l,S+l} and the (S+l)th component of the gradient ∇_{S+l}∫(x^{k}). In addition to the locally available information, each link l, when executing iteration (20), needs to compute the terms:

$${\sum }_{i ∈ S ( l )} {( {H}_{k}^{- 1} )}_{ii} , {\sum }_{i ∈ S ( l )} {( {H}_{k}^{- 1} )}_{ii} {∇}_{i} f ( {x}^{k} ) , {\sum }_{i ∈ S ( l )} {Π}_{i} ( 0 ) , {\sum }_{i ∈ S ( l )} {Π}_{i} ( t ) .$$

The first two terms can be computed by link l if each source sends its local information to the links along its route “once” in primal iteration k. Similarly, the third term can be computed by link l once for every k if the route price πᵢ(0)=Σ_{l∈L(k)}1 (aggregated along the links of a route when link prices are all equal to 1) are sent by the destination to source i, which then evaluates and sends the weighted price Π,(0) to the links along its route. The fourth term can computed with a similar feedback mechanism. However, the computation of this term needs to be repeated for every dual iteration t.

The preceding information exchange suggests the following distributed implementation of (20) (at each primal iteration k) among the sources and the links, where each source or link is viewed as a processor, information available at source i can be passed to the links it traverses, i.e., l∈L(i), and information about the links along a route can be aggregated and sent back to the corresponding source using a feedback mechanism:

Initialization.
1.a Each source i sends its local information (Hₖ)ᵢᵢ and ∇,∫(x^{k}) to the links along its route, l∈L(i). Each link l computes (Hₖ)_{(S+l)(S+l)}⁻¹, Σ_{i∈S(l)}(Hₖ)ᵢᵢ⁻¹, (Πₖ⁻¹)_{(S-l)(S+l)}∇_{S+l}∫(x^{k}) and Σ_{i∈S(l)}(Hₖ⁻¹)ᵢᵢ∇ᵢ∫(x^{k}).
1.b Each link l starts with price wₜ(0|)=1. The link prices wₜ(0) are aggregated along route i to compute π(0)=Σ_{ie∈L,i)}wₜ(0) at the destination. This information is sent back to source i.
1.c Each source computes the weighted price Πᵢ(0)=(Hₖ⁻¹)ᵢᵢΣ_{ie∈L(i)}wᵢ(0) and sends it to the links along its route, l∈L(i).
1.d Each link l then initializes with arbitrary price wₜ(1).

2. Dual Iteration.
2.a the link prices wₗ(t) are updated using (20) and aggregated along route i to compute π(t) at the destination. This information is sent back to source i.
2.b Each source computes the weighted price ∥,(t) and sends it to the links along its route, l∈L(i).

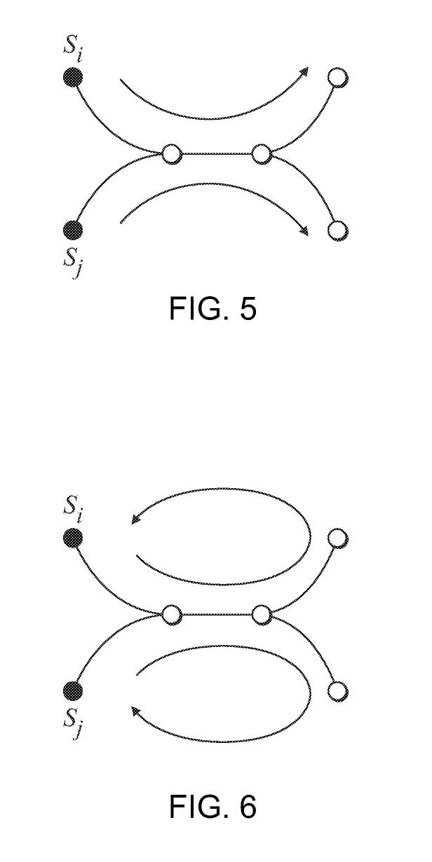

The direction of information flow can be seen in FIGS. 5 and 6. Note that the sources only need to send their Hessian and gradient information once per primal iteration since these values do not change in the dual iterations. Moreover, this method has a comparable level of information exchange with the subgradient based methods applied to the NUM problem (2). In both types of method only the sum of prices of links along a route is fed back to the source, and the links update prices based on scalar information sent from sources using that link.

### Distributed Computation of the Primal Newton Direction

Given the dual vector to w^{k}(i) obtained from the dual iteration (17) in finitely many steps, the primal Newton direction can be computed according to Eq. (9) as

(Δx^{k})ᵢ=−(Hₖ)ᵢᵢ⁻¹(∇ᵢ∫(x^{k})+(A′w^{k}(t))ᵢ)=−(Hₖ)ₑᵢ⁻¹∇ᵢ∫(x^{k})+Πᵢ(t), (25)

where Πᵢ(t) is a weighted price of the route for source i computed at termination of the dual iteration. Hence, the primal Newton direction can be computed using local information by each source. However, because the dual variable computation involves an iterative scheme, the exact value for w^{k} is not available. Therefore, the direction Δx^{k} computed using Eq. (25) may violate the equality constraints in problems (4). To maintain feasibility of the generated primal vectors, the calculation of the inexact Newton direction at a primal vector x^{k}, denoted by Δ\tilde{x}^{k}, is separated into two stages.

In the first stage, the first S components of Δ\tilde{x}^{k}, denoted by [symbol] \tilde{s}^{k}, is computed via Eq. (25) using the dual variables obtained via the iterative scheme, i.e.,

Δ\tilde{s}ᵢ^{k}=−(Hₖ)ᵢᵢ⁻¹(∇ᵢ∫(x^{k})+└R′┐ⁱw^{k}(i). (26)

In the second stage, the last L components Δ\tilde{x}^{k} (corresponding to the slack variables, of. Eq. (3) are computed to ensure that the condition AΔ\tilde{x}^{k}=0 is satisfied, i.e.,

$$Δ {\tilde{x}}^{k} = ( \begin{matrix}Δ {\tilde{s}}^{k} \\ - R Δ {\tilde{s}}^{k}\end{matrix} ) , \qquad ( 27 )$$

which implies Δ\tilde{x}_{l+S}^{k}=−Σ_{i∈S(l)}Δ\tilde{s}ᵢ^{k} for each link l. This calculation at each link l involves computing the slack introduced by the components of Δ\tilde{s}^{k} corresponding to the sources using link l, and hence can be computed in a distributed way.

The method presented generates the primal vectors as follow: Let x⁰ be an initial strictly positive feasible primal vector (see Eq. (6) for one possible choice). For any k≧0

xₖ₊₁=x^{k}+d^{k}Δ\tilde{x}^{k}, (28)

where d^{k} is a positive stepsize and Δ\tilde{x}^{k} is the inexact Newton direction at primal vector x^{k} (obtained through an iterative dual variable computation scheme and a two-stage primal direction computation that maintains feasibility). This algorithm is referred to as the (distributed) inexact Newton method.

The method is inexact due to the iterative computation of the dual vector w^{k} and the modification used to maintain feasibility. If the following bounds on the errors are satisfied, the objective function value generated by the inexact Newton algorithm (with selection of proper stepsize) converges quadratically in terms of primal iterations to an error neighborhood of the optimal value, where the neighborhood can be characterized explicitly using the parameters of the algorithm and the error bounds.

Assumption 2:

Let {x^{k}} denote the sequence of primal vectors generated by the distributed inexact Newton method. Let Δx^{k} and Δ\tilde{x}ₖ denote the exact and inexact Newton directions at x^{k}, and γ^{k} denote the error in the Newton direction computation, i.e.,

Δx^{k}=Δ\tilde{x}^{k}+γₖ. (29)

For all k, γ^{k} satisfies

|(γ^{k})′∇₂∫(x^{k})γ^{k}|≦p²(Δ\tilde{x}^{k})′∇²∫(x^{k})Δ\tilde{x}^{k}+∈. (30)

for some positive scalars p<1 and ∈.

This assumption imposes a bound on the weighted norm of the Newton direction error γₖ as a function of the weighted norm of Δ\tilde{x}^{k} and a constant ∈. Note that, without the constant ∈, this error to would be required to vanish when x^{k} is close to the optimal solution, i.e., when Δ\tilde{x}^{k} is small, which is impractical for implementation purposes. Given p and ∈, one can use the distributed scheme presented in the following section to guarantee the preceding assumption is satisfied.

### Distributed Error Checking

A distributed error checking method is used to determine when to terminate the dual computation procedure to meet the error tolerance level in Assumption 2 at a fixed primal iteration k. The method involves two stages: in the first stage, the links and sources execute a predetermined number of dual iterations. In the second stage, if the error tolerance level has yet not been satisfied, the links and sources implement dual iterations until some distributed termination criteria is met. The dependence of the dual vector on the primal iteration index k is suppressed for notational convenience and the following assumption on the information available to each node and link is adopted.

Assumption 3:

There exists a positive scalar F<: 1 such that the spectral radius of the matrix M=(Dₖ+ B̅ₖ)⁻¹( B̅ₖ−Bₖ) satisfies ρ(M)≦F. Each source and link knows the scalar F and the total number of sources and links in the graph, denoted by S and L respectively.

The value F can vary across different primal iterations. As observed in [30], the bound F coincides with a bound on a largest eigenvalue of a Laplacian matrix of a graph related to the network topology. These bounds can be obtained based on the known results from graph theory [10j, [51. In this assumption, only some aggregate information is required to be available and hence the distributed nature of the algorithm is preserved. A relation between ∥w*−w(t)∥_{∞} and ∥w(t+1)−w(t)∥_{∞} used in developing the method, is provided below.

### Lemma 4.5.

Let the matrix M be M=(Dₖ+ B̅ₖ)⁻¹( B̅ₖ−Bₖ). Let w(t) denote the dual variable generated by iteration (17), and w* be the fixed point of the iteration. Let F and L be the positive scalar defined in Assumption 3. Then the following relation holds,

$${‖ {w}^{*} - w ( t ) ‖}_{∞} \leq \frac{\sqrt{L}}{1 - F} {‖ w ( t + 1 ) - w ( t ) ‖}_{∞} . \qquad ( 31 )$$

Iteration (17) implies that the fixed point w* satisfies the following relation,

w*=Mw*|(Dₖ| B̅ₖ)⁻¹(−AHₖ⁻¹∇ƒ(x^{k})),

and the iterates w(t) satisfy,

w(t+1)=Mw(t)+(Dₖ+ B̅ₖ)⁻¹(−AHₖ⁻¹∇ƒ(x^{k}))).

Combining the above two relations obtains:

w(t+1)=Mw(t)+(Dₖ+ B̅ₖ)⁻¹(−AHₖ⁻¹∇∫(x^{k})).

Hence, by the definition of matrix infinity norm,

∥w*−w(t)∥_{∞}≦∥(1−M)⁻¹∥_{∞}∥w(t+1)−w(t)∥_{∞}.

Using norm equivalence for finite dimensional Euclidean space and theories of linear algebra,

$${‖ {( I - M )}^{- 1} ‖}_{∞} \leq \sqrt{L} {‖ {( I - M )}^{- 1} ‖}_{2} \leq \frac{\sqrt{L}}{1 - {‖ M ‖}_{2}}$$

is obtained. For the symmetric real matrix M, ρ(M)=∥M∥₂ can be determined and thus the desired relation can be obtained.

The above lemma can be used to develop two theorems, each of which corresponds to one stage of the distributed error checking method.

Theorem 4.6:

Let {x^{k}} be the primal sequence generated by the inexact Newton method (28) and Hₖ be the corresponding Hessian matrix and the k^{th} iteration. Let w(t) be the inexact dual variable obtained after t dual iterations (17) and w* be the exact solution to (10), i.e. the limit of the sequence

{w(t)} as t→∞. Let vectors Δx^{k} and Δ\tilde{x}^{k} exact and inexact Newton directions obtained using w* and w(t) [cf. Eqs. (26)-(27)], and vector γ^{k} be the error in the Newton direction computation at x^{k}, defined by γ^{k}=Δx^{k}−Δ\tilde{x}^{k}. For some positive scalar p,

$$let {ρ}_{i} = \vert \frac{\sqrt{L} {( {H}_{k}^{- 1} )}_{ii} \vert L ( i ) \vert {‖ w ( t + 1 ) - w ( t ) ‖}_{∞}}{( 1 - F ) {{( {H}_{k}^{- 1} )}_{ii} [ {R}^{′} ]}^{i} w ( t )} \vert \qquad ( 32 )$$

for each source i, and

$${ρ}_{l} = \vert \frac{\sqrt{L} {\sum }_{i ∈ S ( l )} {( {H}_{k}^{- 1} )}_{ii} \vert L ( i ) \vert {‖ w ( t + 1 ) - w ( t ) ‖}_{∞}}{( 1 - F ) {\sum }_{i ∈ S ( l )} {{( {H}_{k}^{- 1} )}_{ii} [ {R}^{′} ]}^{i} w ( t )} \vert \qquad ( 33 )$$

for each link l. Define a nonnegative scalar β^{k} as

$$\begin{matrix}{β}_{k} = {( max \{ {max}_{i ∈ S} \frac{{ρ}_{i}}{p} , {max}_{l ∈ ℒ} \frac{{ρ}_{l}}{p} \} )}^{- 2} . \\ Then & ( 34 ) \\ {{β}^{k} ( {γ}^{k} )}^{′} {H}_{k} {γ}^{k} \leq {{p}^{2} ( Δ {\tilde{x}}^{k} )}^{′} {H}_{k} ( Δ {\tilde{x}}^{k} ) . & ( 35 )\end{matrix}$$

For notational convenience, matrix Pₖ denotes the S×S principal submatrix of Hₖ, i.e., (Pₖ)ₕ=(Hₖ)ᵢᵢ for i≦S, vector Δ\tilde{s} in [symbol] denote the first S components of the vector Δ\tilde{x}^{k}, vector Δ\tilde{y}ₗ in [symbol] denote the last L components of the vector Δ\tilde{x}^{k}. Similarly, the first S and last L components of the exact Newton direction Δx are denoted by Δs and Δy respectively. From Eq. (26) it is provided that for each i∈S:

$$\vert \frac{Δ {s}_{i} - Δ {\tilde{s}}_{i}}{Δ {\tilde{s}}_{i}} \vert = \vert \frac{{{( {H}_{k}^{- 1} )}_{ii} [ {R}^{′} ]}^{i} ( {w}^{*} - w ( t ) )}{{{( {H}_{k}^{- 1} )}_{ii} [ {R}^{′} ]}^{i} w ( t )} \vert \leq \vert \frac{{{( {H}_{k}^{- 1} )}_{ii} [ {R}^{′} ]}^{i} e {‖ {w}^{*} - w ( t ) ‖}_{∞}}{{{( {H}_{k}^{- 1} )}_{ii} [ {R}^{′} ]}^{i} w ( t )} \vert \leq \vert \frac{\sqrt{L} {( {H}_{k}^{- 1} )}_{ii} \vert L ( i ) \vert {‖ w ( t + 1 ) - w ( t ) ‖}_{∞}}{( 1 - F ) {{( {H}_{k}^{- 1} )}_{ii} [ {R}^{′} ]}^{i} w ( t )} \vert = {ρ}_{i} .$$

where the first inequality follows from the element non-negativity of matrices Hₖ and R, and the second inequality follows from relation (31).

Similarly for each link l∈L relations (26) and (27):

$$\vert \frac{Δ {y}_{l} - Δ {\tilde{y}}_{l}}{Δ {\tilde{y}}_{l}} \vert = \vert \frac{{[ R ]}^{l} {P}_{k}^{1} {R}^{′} ( {w}^{*} - w ( t ) )}{{[ R ]}^{l} {P}_{k}^{- 1} {R}^{′} w ( t )} \vert \leq \vert \frac{{\sum }_{i ∈ S ( l )} {( {P}_{k}^{- 1} )}_{ii} e {‖ {w}^{*} - w ( t ) ‖}_{∞}}{{\sum }_{i ∈ S ( l )} {{( {P}_{k}^{- 1} )}_{ii} [ {R}^{′} ]}^{i} w ( t )} \vert \leq \vert \frac{\sqrt{L} {\sum }_{i ∈ S ( l )} {( {H}_{k}^{- 1} )}_{ii} \vert L ( i ) \vert {‖ w ( t + 1 ) - w ( t ) ‖}_{∞}}{( 1 - F ) {\sum }_{i ∈ S ( l )} {{( {H}_{k}^{- 1} )}_{ii} [ {R}^{′} ]}^{i} w ( t )} \vert = {ρ}_{i} ,$$

where the first inequality follows from the structure of the matrix R and the element-wise nonnegativity of matrices Hₖ and R, and the second inequality follows from relation (31) and the definition for matrix Pₒ.

The definition for β^{k} [cf. Eq. (34)] implies that

$$\frac{p}{\sqrt{{β}^{k}}} = max \{ {max}_{i ∈ S} {ρ}_{i} , {max}_{i ∈ ℒ} {ρ}_{l} \} .$$

Therefore the preceding relations imply that

$$\vert \frac{Δ {s}_{i} - Δ {\tilde{s}}_{i}}{Δ {\tilde{s}}_{i}} \vert \leq \frac{p}{\sqrt{{β}^{k}}} and \vert \frac{Δ {y}_{l} - Δ {\tilde{y}}_{l}}{Δ {\tilde{y}}_{l}} \vert \leq \frac{p}{\sqrt{{β}^{k}}} , i . e . , \sqrt{{β}^{k}} \vert γ \vert \leq p \vert Δ {\tilde{x}}_{i} \vert ,$$

which implies the desired relation.

### Theorem 4.7.

Let {x^{k}} be the primal sequence generated by the inexact Newton method (28) and Hₖ, be the corresponding Hessian matrix at k^{th} iteration. Let w(t) be the inexact dual variable obtained after t dual iterations (17) and w* be the exact solution to (10), i.e. the limit of the sequence {w(t)} as t→∞. Let vectors Δx^{k} and Δ\tilde{x}^{k} be the exact and inexact Newton directions obtained using w* and w(t) [cf. Eqs. (20)-(27)] respectively, and vector γ^{k} be the error in the Newton direction computation at x^{k}, defined by γ^{k}−Δc^{k}−Δ\tilde{x}^{k}. For some scalar β and ∈ where 0<β^{k}<1 and ∈>0, let

$${h}_{i} = \sqrt{\frac{\text{?}}{( 1 - {β}^{k} ) {( L + S )}^{L}}} \frac{1 - F}{\vert L ( i ) \vert {( {H}_{k}^{- \frac{1}{2}} )}_{ii}} \\ \text{?} \text{indicates text missing or illegible when filed} \qquad ( 36 )$$

for each source i, and

$${h}_{i} = \sqrt{\frac{\text{?}}{( 1 - {β}^{k} ) {( L + S )}^{L}}} \frac{1}{{( {H}_{k}^{\frac{1}{2}} )}_{( s + l ) ( s + l )} {\sum }_{i ∈ S ( L )} \vert L ( i ) \vert {( {H}_{k} )}_{ii}^{- 1}} \\ \text{?} \text{indicates text missing or illegible when filed} \qquad ( 37 )$$

for each link l. Define a nonnegative scalar h as

$$h = ( min \{ {min}_{i ∈ S} {h}_{i} , \text{?} {h}_{i} \} ) . \\ \text{?} \text{indicates text missing or illegible when filed} \qquad ( 38 )$$

Then the condition

∥w(t+1)−w(t)∥_{∞}≦h (39)

implies

$$\text{?} {H}_{k} {γ}^{k} \leq \frac{c}{1 - {β}^{k}} . \\ \text{?} \text{indicates text missing or illegible when filed} \qquad ( 40 )$$

for Δ\tilde{x}^{k} obtained according to (27) using w(t).

Let matrix Pₖ denote S×S principal sub-matrix (Pₖ)ᵢ(Hₖ)ᵢᵢ for i≦S, for notational convenience. The definition of h [cf. Eq. (38)] and relation (39) implies:

∥w(t+1)−w(t)∥_{∞}≦hᵢ,∈S,

and

∥w(t+1)−w(t)∥_{∞}≦hₗ, for l∈L,

Using relation (31) and the definition of hᵢ and hₗ [cf. Eqs. (36) and (37)], the above two relations implies respectively that

$$\begin{matrix} {‖ {w}^{*} - w ( i ) ‖}_{∞} \leq \sqrt{\frac{\text{?}}{( 1 - {β}^{k} ) ( L + S )}} \frac{1}{\vert L ( i ) \vert {( {H}_{k}^{- \frac{1}{2}} )}_{ii}} , \\ for i ∈ S , \\ \text{?} \text{indicates text missing or illegible when filed} \\ and & ( 41 ) \\ {‖ {w}^{*} - w ( i ) ‖}_{∞} \leq \sqrt{\frac{\text{?}}{( 1 - {β}^{k} ) ( L + S )}} \frac{1}{{( {H}_{k}^{\frac{1}{2}} )}_{( s + l ) ( s + l )} {\sum }_{i ∈ S ( L )} \vert L ( i ) \vert {( {H}_{k} )}_{ii}^{- 1}} , \\ for 1 ∈ ℒ . \\ \text{?} \text{indicates text missing or illegible when filed} & ( 42 )\end{matrix}$$

By using the element-wise non-negativity of matrices H and A, for source i:

|(Hₖ^{1/2})ᵢₙ|R′|ⁱ(w*−w(t))|≦(Hₖ^{-1/2})ᵢᵢ|R′|ⁱ_{c}∥w*−w(t)∥_{∞}−|L(i)|(Hₖ^{-1/2})ᵢᵢ∥w*−w(t)∥_{∞}.

where the last equality follows from the fact that |R′|ⁱe=|L(i)| for each source i.

The above inequality and relation (41) imply

$$\vert {( {H}_{k}^{- \frac{1}{2}} )}_{ii} [ \text{?} \vert \leq \sqrt{\frac{\text{?}}{( 1 - {β}^{k} ) ( L + S )}} . \\ \text{?} \text{indicates text missing or illegible when filed} \qquad ( 43 )$$

By the definition of matrixes Pₖ and R, for each link l:

$$\vert {( {H}_{k}^{\frac{1}{2}} )}_{( S + l ) ( S - l )} {( {RP}_{k}^{- 1} \text{?} ( {w}^{*} - w ( i ) ) )}^{t} \vert \leq {{( {H}_{k}^{\frac{1}{2}} )}_{( S + l ) ( S - l )} [ R ]}^{t} {P}_{k}^{- 1} \text{?} {‖ {w}^{*} - w ( i ) ‖}_{∞} = {( {H}_{k}^{\frac{1}{2}} )}_{( S + l ) ( S - l )} {\sum }_{i ∈ S ( L )} \vert L ( i ) \vert {( {H}_{k} )}_{ii}^{- 1} {‖ {w}^{*} - w ( i ) ‖}_{∞} . \\ \text{?} \text{indicates text missing or illegible when filed}$$

When combined with relation (42), the preceding relation yields

$$\vert {( {H}_{k}^{\frac{1}{2}} )}_{( S + l ) ( S - l )} {( {RP}_{k}^{- 1} \text{?} ( {w}^{*} - w ( i ) ) )}^{t} \vert \leq \sqrt{\frac{\text{?}}{( 1 - {β}^{k} ) ( L + S )}} \\ \text{?} \text{indicates text missing or illegible when filed} \qquad ( 44 )$$

From Eqs. (26-27) and the definition of y:

$${γ}_{i}^{k} = - ( \begin{matrix}{P}_{k}^{- 1} \text{?} ( {w}^{*} - w ( i ) ) \\ {RP}_{k}^{- 1} \text{?} ( {w}^{*} - w ( i ) )\end{matrix} ) , \\ \text{?} \text{indicates text missing or illegible when filed}$$

which implies that

$$\text{?} {H}_{k} {γ}^{k} = {\sum }_{i ∈ S} {( ( \text{?} ) [ \text{?} ] ( {w}^{*} - w ( i ) ) )}^{2} + {\sum }_{I ∈ ℒ} {( {( {H}_{k}^{\frac{1}{2}} )}_{( S + l ) ( S - l )} {( {RP}_{k}^{- 1} \text{?} ( {w}^{*} - w ( i ) ) )}^{l} )}^{2} \leq \frac{ε}{1 - {β}^{k}} , \\ \text{?} \text{indicates text missing or illegible when filed}$$

where the inequality follows from (43), (44), which establishes the desired relation.

To develop the distributed error checking method based on the preceding two theorems:

### Stage 1:

The links and sources implement T iterations of (17), where T is a predetermined globally known constant. The links and sources then use Theorem 4.6 with t=T−1 and p as the desired relative error tolerance level defined in Assumption 2 to obtain a value β^{k} if β^{k}>1, then the dual iteration terminates.

### Stage 2:

The links and sources use Theorem 4.7 with obtained in the first stage and E defined in Assumption 2 to obtain value h. Then they perform more iterations of the form (17) until the criterion (39) is satisfied.

Stage 1 corresponds to checking the term p²(Δ\tilde{x}^{k})′Hₖ(Δ\tilde{x}^{k}), while Stage 2 corresponds to the term ∈ in the error tolerance level. If the method terminates the dual iterations in Stage 1, then Theorem 4.6 suggests that Assumption 2 is satisfied for any ∈>0; otherwise, by combining relations (35) and (40):

(γ^{k})′Hₖγ^{k}=(β^{k}+(1−β^{k}))(γ^{k})′Hₖγ^{k}≦p²(Δ\tilde{x}^{k})′Hₖ(Δ\tilde{x}^{k})+∈₁

which shows that the error tolerance level in Assumption 2 is satisfied.

To show that the above method can be implemented in a distributed way, first rewrite the terms ρᵢ, ρₗ, hᵢ and hₗ and analyze the information required to compute them in a decentralized way. Using the definition of the weighted price of the route Πᵢ(t) obtains:

Πᵢ(t)=(Hₖ⁻¹)ᵢᵢΣ_{l∈L(i)}w(i)=(Hₖ⁻¹)ᵢᵢ|R′|ⁱw(i) and Πᵢ(0)=(Hₖ⁻¹)ᵢᵢ|L(i)|, where wₜ(0)=1

for all links l. Therefore relations (32) and (33) can be rewritten as

$${ρ}_{i} = \vert \frac{\sqrt{L} {Π}_{i} ( 0 ) {‖ w ( i + 1 ) - w ( i ) ‖}_{∞}}{( 1 - F ) {Π}_{i} ( i )} \vert , \\ {ρ}_{i} = \vert \frac{\sqrt{L} {\sum }_{v ∈ S ( i )} {Π}_{i} ( 0 ) {‖ w ( i + 1 ) - w ( i ) ‖}_{∞}}{( 1 - F ) {\sum }_{v ∈ S ( i )} {Π}_{i} ( i )} \vert .$$

Similarly, relations (36) and (37) can be transformed into

$${h}_{i} = \sqrt{\frac{ε}{( 1 - {β}^{k} ) ( L + S ) L}} \frac{1 - F}{{π}_{i} ( 0 ) {( {H}_{k}^{- \frac{1}{2}} )}_{ii}} , \\ {h}_{i} = \sqrt{\frac{ε}{( 1 - {β}^{k} ) ( L + S ) L}} \frac{1 - F}{{( {H}_{k}^{\frac{1}{2}} )}_{( s + l ) ( s + l )} {\sum }_{i ∈ S ( L )} {Π}_{i} ( 0 )} .$$

In the dual variable computation procedure, the values πᵢ(0), Πᵢ(0) and Πᵢ(t) are readily available to all the links l∈L(i) through the feedback mechanism described in Section 4.2. Each source and link knows its local Hessian, i.e., (Hₖ)ᵢᵢ for source i and (Hₖ)_{(S+l)(S+l)} for link l. The value β^{K} is only used in Stage 2 and it is available from the previous stage. Therefore in the above four expressions, the only information not immediately available is ∥w(t+1)−w(t)∥_{∞}, which can be obtained using a maximum consensus algorithm. Based on these four terms, the values of β^{K} and h can be obtained using once again maximum consensus and hence all the components necessary for the error checking method can be computed in a distributed way.

In the first T iterations, i.e., Stage 1, only two executions of maximum consensus algorithms is required, where one is used to compute ∥w(t+1)−w(t)∥_{∞} and the other for β^{K}. However, even though the computation of the value h in Stage 2 needs only one execution of the maximum consensus algorithm, the term ∥w(t+1)−w(t)∥_{√} needs to be computed at each dual iteration t. Therefore the error checking in Stage 1 can be completed much more efficiently than in Stage 2. Hence, when designing values ρ and ∈ in Assumption 2, ρ should be chosen to be relatively large whenever possible, resulting in an error checking method that does not enter Stage 2 frequently, and is hence faster. Other than the distributed error checking method described herein, a distributed scheme to explicitly compute, at each primal iteration, a bound on the number of dual steps that can satisfy the error level may be used.

### Stepsize Rule

Based on the preceding analyses, the inexact Newton direction Δ\tilde{x}^{k} can be computed in a distributed way, the only other unknown term in the update equation (28) being the stepsize d^{K}. A stepsize rule that can achieve a local superlinear convergence rate (to an error neighborhood) for the primal iterations is desirable and achievable using a distributed procedure to compute the stepsize. Using such a stepsize rule, the primal vectors x^{K} remain strictly positive for all k, thereby ensuring that the Hessian matrix and therefore the (inexact) Newton direction are well-defined at all iterates (see Eq. (11)).

In accordance with various embodiments, the stepsize rule will be based on an inexact version of the Newton decrement. At a given primal vector x^{k} (with Hessian matrix Hₖ), the exact Newton direction, denoted by Δx^{k}, is defined as the exact solution of the system of equations (8). The exact Newton decrement λ(x^{k}) is defined as:

λ(x^{k})=\sqrt{(Δx^{k})′HₖΔx^{k}}. (45)

Similarly, the inexact Newton decrement \tilde{λ}(x^{k}) is given by

\tilde{λ}(x^{k})=\sqrt{(Δ\tilde{x}^{k})′HₖΔ\tilde{x}^{k}},

where Δ\tilde{x}^{k} is the inexact Newton direction at primal vector x^{k}. Note that both λ(x^{k}) and \tilde{λ}(x^{k}) are nonnegative and well-defined due to the fact that the matrix Hₖ=∇²∫(x^{k}) is positive definite.

Given the scalar \tilde{λ}(x^{k}), at each iteration k the stepsize d^{k} as follows: Let V be some positive scalar with 0<V<0.267. Thus

$${d}^{k} = \{ \begin{matrix}\text{?} & if \tilde{λ} ( {x}^{k} ) \geq V for all previous k , \\ 1 & otherwise .\end{matrix} \\ \text{?} \text{indicates text missing or illegible when filed} \qquad ( 47 )$$

The upper bound on V guarantees local quadratic convergence. The fact that V<1 also ensures starting with a strictly positive feasible solution, the primal vectors x^{k} remain strictly positive for all k.

### Distributed Inexact Newton Decrement Computation

Note that in Eq. (47), the only unknown term is the inexact Newton decrement \tilde{λ}(x^{k}). In order to compute the value of \tilde{λ}(x^{k}), the inexact Newton decrement can be rewritten as

$$\tilde{λ} ( {x}^{k} ) = \sqrt{{\sum }_{i ∈ S} {( Δ {\tilde{x}}_{i}^{k} )}^{2} {( {H}_{k} )}_{ii} + \text{?} {( Δ {\tilde{x}}_{i + S}^{k} )}^{2} ( {H}_{k} ) \text{?}} , \\ or equivalently , \\ {( \tilde{λ} ( {x}^{k} ) )}^{2} = {\sum }_{i ∈ S} {( Δ {\tilde{x}}_{i}^{k} )}^{2} {( {H}_{k} )}_{ii} + \text{?} {( Δ {\tilde{x}}_{i + S}^{k} )}^{2} ( {H}_{k} ) \text{?} . \\ \text{?} \text{indicates text missing or illegible when filed}$$

Description of a distributed summation procedure to compute this quantity by aggregating the local information available on sources and links is provided in further detail below. A key feature of this procedure is that it respects the simple information exchange mechanism used by first order methods applied to the NUM problem: information about the links along the routes is aggregated and sent back to the sources using a feedback mechanism. Over-counting is avoided using an off-line construction, which forms an (undirected) auxiliary graph containing information regarding sources sharing common links.

Given a network with source set S={1, 2 . . . , S} (each associated with a predetermined route) and link set: L=(1, 2, . . . , L), the set of nodes in the auxiliary graph is defined as set S, i.e., each node corresponds to a source (or equivalently, a flow) in the original network. The edges are formed between sources that share common links according to the following iterative construction. In this construction, each source is equipped with a state (or color) and each link is equipped with a set (a subset of sources), which are updated using signals sent by the sources along their routes.

### Auxiliary Graph Construction:

Initialization:

Each link l is associated with a set Θₗ=0. One arbitrarily chosen source is marked as grey, and the rest are marked as white. The grey source sends a signal {label, i} to its route. Each link l receiving the signal, i.e., l∈L(i), adds i to Θₗ.

Iteration:

In each iteration, first the sources update their states and send out signals according to step (A). Each link l then receives signals sent in step (A) from the sources i∈S(L) and updates the set Θᵢ according to step (B).

Each source i:
(A.a) If it is white, it sums up led ∥Θᵢ| along its route, using the value |Θᵢ| from the previous time.
(A.a.1) If Σ_{l∈L(i)}|Θᵢ|>0, then the source i is marked grey and it sends two signals {neighbor, i} and {label, i} to its route.
(A.a.2) Else, i.e., Σ_{l∈L(i)}|Θᵢ|=0 source i does nothing for this iteration.

(A.a) Otherwise, i.e., it is grey, source i does nothing.

(B) Each link l:

(B.a) If Θₗ=:
(B.a.1) if it experiences signal {label, i} passing through it, it adds i to Θₗ. When there are more than one such signals during the same iteration, only the smallest i is added. The signal keeps traversing the rest of its route.
(B.a.2) Otherwise link l simply carries the signal(s) passing through it, if any, to the next link or node.

(B.b) Else, i.e., Θₗ≠:
(B.b.1) If it experiences signal {neighbor, i} passing through it, an edge (i, j) with label Lₗ is added to the auxiliary graph for all j∈Θₗ, and then i is added to the set Θₗ. If there are more than one such signals during the same iteration, the sources are added sequentially, and the resulting nodes in the set Θₗ form a clique in the auxiliary graph. Link l then stops the signal, i.e., it does not pass the signals to the next link or node.
(B.b.2) Otherwise link l simply carries the signal(s) passing through it, if any, to the next link or node.

Termination:

Terminate after S−1 number of iterations.

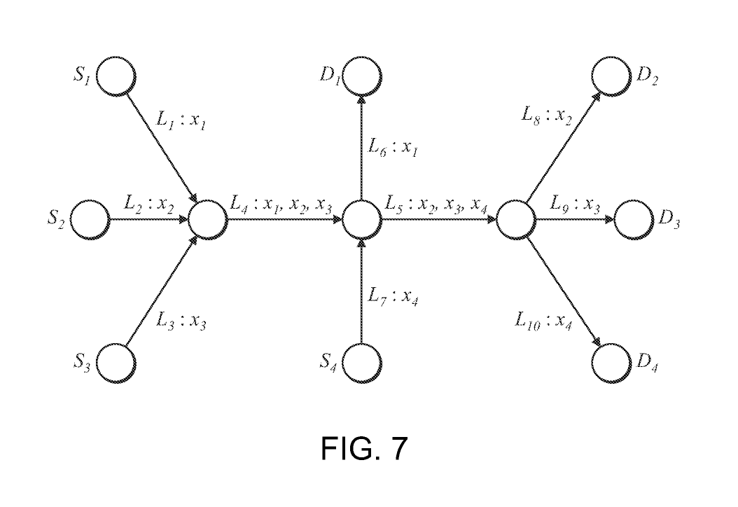

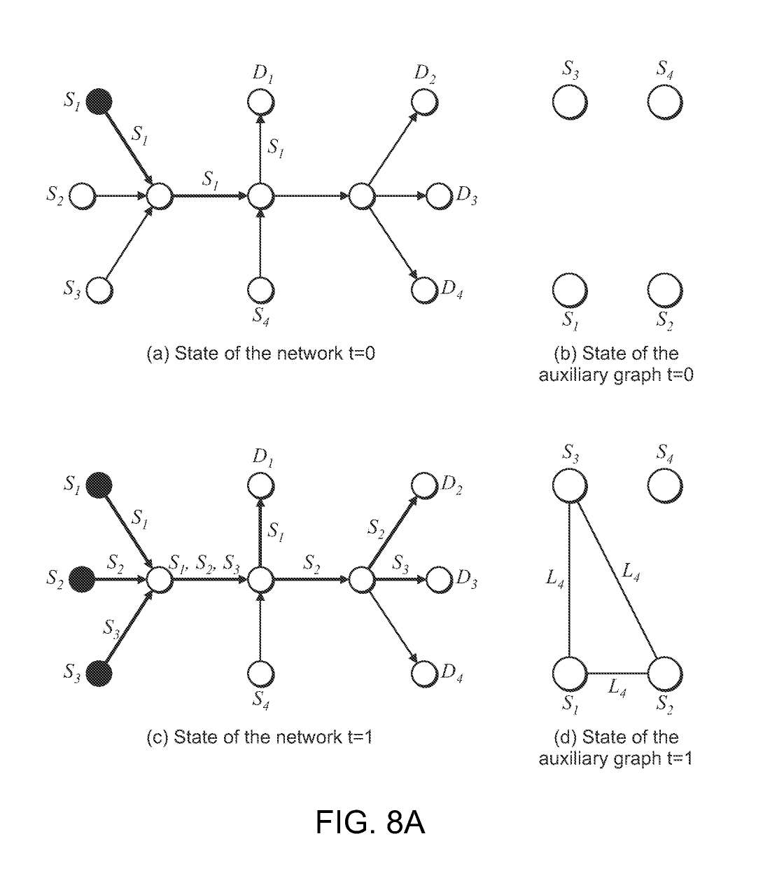

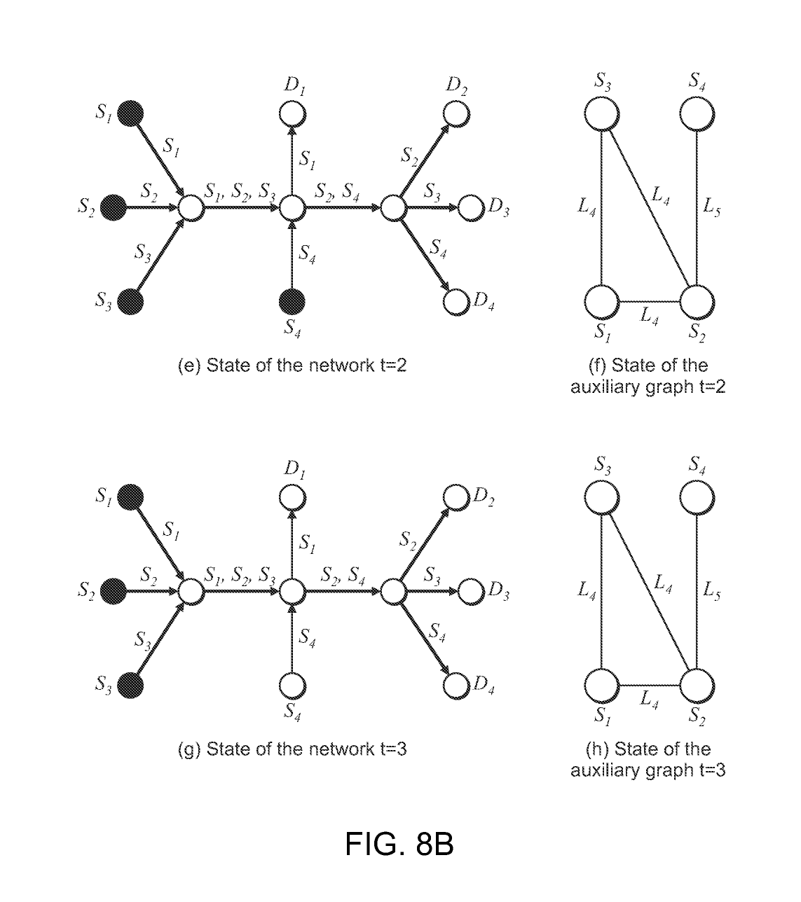

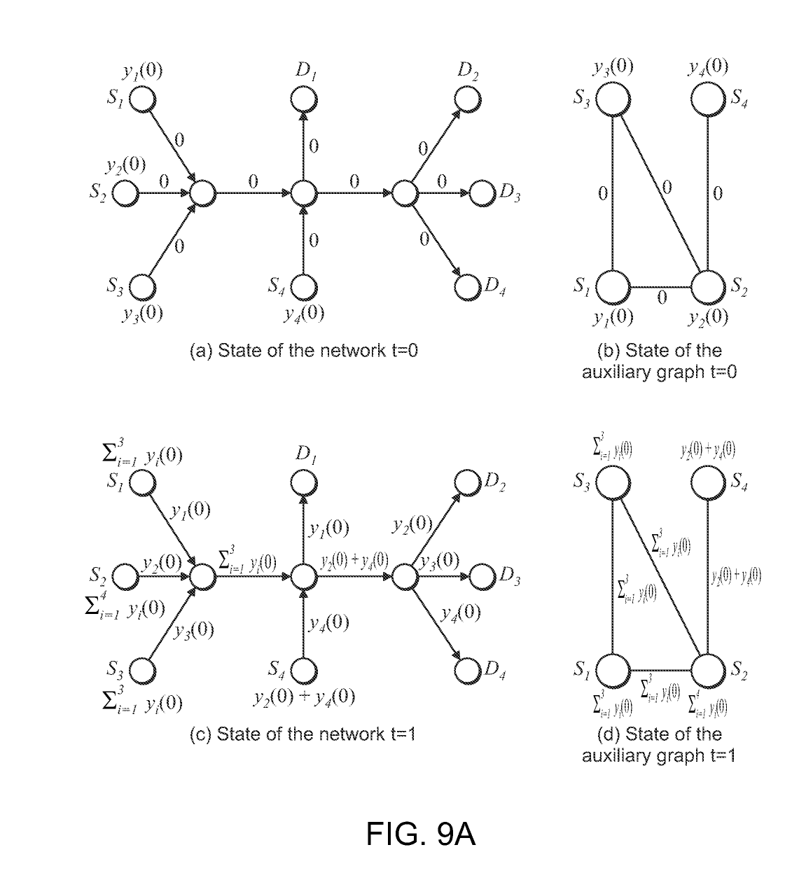

The auxiliary graph construction process for the sample network in FIG. 7 is illustrated in FIG. 8, where the left column reflects the color of the nodes in the original network and the elements of the set et Θₗ (labeled on each link l), while the right column corresponds to the auxiliary graph constructed after each iteration.

Lemma 4.8:

The following statements hold for a network and its auxiliary graph with sets {Θₗ}_{l∈L}:
(1) For each link l, Θₗ⊂S(l).
(2) Source nodes i, j are connected in the auxiliary graph if and only if there exists a link l, such that {i, j}⊂Θₗ.
(3) The auxiliary graph does not contain multiple edges, i.e., there exists at most one edge between any pair of nodes.
(4) The auxiliary graph is connected.
(5) For each link l, Θₗ≠.
(6) There is no simple cycle in the auxiliary graph other than that formed by only the edges with the same label.
   where
(1) Part (1) follows immediately from the auxiliary graph construction, because each source only sends signals to links on its own route and the links only update their set Θₗ when they experience some signals passing through them.
(2) In the auxiliary graph construction, a link is added to the auxiliary graph only in step (B.b.1), where part (2) clearly holds.
(3) From the first two parts, there is an edge between source nodes i, j, i.e., {i, j}⊂Θₗ for some l, only if i and j share link l in the original network. From the auxiliary graph construction, if sources i and j slime link l then an edge with label Lᵢ between i and j is formed at some iteration if and only if one of the following three cases holds:

In the beginning of the previous iteration Θₗ− and sources i,j are both white. During the previous iteration, source i becomes grey and sends out the signal {label,i} to link l, hence Θₗ={i}. In the current iteration, source j with Σ [symbol] |Θₙ|≧|Θ₁|>0 becomes grey and sends out signal {neighbor, j} to link l.

The symmetric case of I, where first source j becomes grey and one iteration later source i becomes grey: In the beginning of the previous iteration Θᵢ= and sources i,j are both white. During the previous iteration, some other source t with l∈L(t) becomes grey and sends out the signal {label, t} to link l, hence Θₗ−{t}. In the current iteration, both source i and j with Σ_{m∈L(i)}|Θₘ≧|Θₗ|>0 and Σ_{m∈L(j)}|Θₘ|≧|Θₗ|>0 become grey and send out signals {neighbor, i} and {neighbor, j} to link l.

Hence, if an edge connecting nodes i and j exists in the auxiliary graph, then in the beginning of the iteration when the edge is formed at least one of the nodes is white, and by the end of the iteration both nodes are colored grey and stay grey. Therefore the edges between i and j in the auxiliary graph can only be formed during exactly one iteration.

Only one such edge can be formed in one iteration. The first two cases below are symmetric, and without loss of generality, cases I and III are described. In both of these cases, an edge between i and j is formed with label Lᵢ only if link l receives the signal {neighbor, j} and Θₜ≠. In step (B.b.1) of the auxiliary graph construction, the first link with Θₗ≠ stops the signal from passing to the rest of its route, hence at most one edge between i and j can be generated. Hence part (3) holds.

(4) It will be apparent in view of this disclosure that, by using a similar analysis as above, if, at one iteration source i from the original network becomes grey, then in the next iteration all the sources which share link with i become grey and are connected to i in the auxiliary graph. Because all the nodes in the auxiliary graph corresponding to sources colored grey in the original network are connected to the source node marked grey in the initialization step, these nodes form a connected component.

In various embodiments, all nodes are colored grey when the auxiliary graph construction procedure terminates. In such embodiments, at least one node is marked grey from white at each iteration before all nodes are marked grey. If the contrary were true, at some iteration no more nodes were marked grey and there still existed a set of white nodes S^{x}, it would imply that the nodes in S* do not share any links with the nodes in S\S* and thus there would be no path from any source in the set S\S* to any source in S* using the links (including the feedback mechanisms) in the original network. However, such a scenario contradicts the fact that all links form a strongly connected graph. Therefore, after S−1 iterations, all nodes in the original graph are colored grey.

(5) Analysis for part (3) suggests that all the connected nodes in the auxiliary graph are colored grey. In view of the part (4), all the sources are colored grey when the auxiliary graph construction procedure terminates. Step (B.a.1) implies that a link has Θₜ= if all sources i∈S(l) are white. Since each link is used by at least one source, and all sources are grey, part (5) holds.

(6) The auxiliary graph, when the cycles formed by the edges of the same label are removed, is acyclic. For each link l let i*ₗ denote the first element added to the set θₗ in the auxiliary graph construction process, which is uniquely defined for each link l by Step (B.a.1). In the set S for each link l, define an equivalence class by i˜j if {i,j}⊂Θₗ\{i*ᵢ}, which implies if and only if i and j are connected in the auxiliary graph and i˜j, this link is formed by scenario III as defined above.

The nodes in each equivalence class are connected by edges with the same label, which form the undesired cycles. These cycles may be removed by merging each equivalence class into one representative node, which inherits all the edges going between the nodes in the equivalence class and S\Θₗ in the auxiliary graph, and is connected to i*ₗ via one edge. Note the resulting graph is connected, since the auxiliary graph is by part (4) and all the remaining edges are generated under scenarios I and II as defined hereinabove with reference to part (3).

The resulting graph contains no cycle. From cases I and II, it follows immediately that an edge is generated when one more source becomes grey. Therefore if number of nodes is N, then N−1 edges exist. In a connected graph, this implies a tree, i.e., acyclic, and hence part (6) holds.

The set of links inducing edges in the auxiliary graph is denoted as L*={l∥Θₗ|>1} and for each source i the set of links which induce edges in the auxiliary graph as L*(i)={l|i∈Θₗ, l∈L*}⊂L(i) for notational convenience. Each link can identify if it is in L* by the cardinality of the set Θₗ. Each source i can obtain |L*(i)| along the links on its route. The auxiliary graph remains the same throughout the distributed inexact Newton algorithm and only depends on the structure of the network (independent of the utility functions and link capacities), therefore given a network, the above construction only needs to be preformed once prior to execution of the distributed Newton algorithm.

A distributed procedure to compute the sum in Eq. (48) follows, showing that the sets Θₗ constructed using the above procedure avoids over-counting and enables computation of the correct values.

### Distributed Summation Procedure:

Initialization:

Each link l initializes to zₗ(0)=0. Each source i computes y*ᵢ=(Δ\tilde{x}ᵢ^{k})²(Hₖ)ᵢᵢ and each link l computes

$${z}_{i}^{*} = \text{?} {( Δ {\tilde{x}}_{l + S}^{k} )}^{2} {( {H}_{k} )}_{( l + S ) ( l - S )}$$

$$\text{?} \text{indicates text missing or illegible when filed}$$

Each source i aggregates the sum

$${y}_{i} ( 0 ) = \text{?} {\sum }_{i ∈ L ( i )} {z}_{i}^{*} \\ \text{?} \text{indicates text missing or illegible when filed} \qquad ( 49 )$$

along its route.
Iteration for t=1, 2, . . . S. The following 3 steps are completed in the order they are presented.
a. Each source i sends its current value yᵢ(l) to its route.
b. Each link l uses the yᵢ(l) received and computes

$$\text{?} ( t ) = \text{?} {y}_{i} ( t - 1 ) - ( \vert {θ}_{t} \vert - 1 ) {z}_{i} ( t - 1 ) . \\ \text{?} \text{indicates text missing or illegible when filed} \qquad ( 50 )$$

c. Each source i aggregates information along its route from the links l∈L*(i) and computes

$${y}_{i} \text{?} = \text{?} {z}_{i} \text{?} - ( \vert \text{?} ( i ) \vert - 1 ) {y}_{i} ( t - 1 ) . \\ \text{?} \text{indicates text missing or illegible when filed} \qquad ( 51 )$$

Termination:

Terminate after S number of iterations.

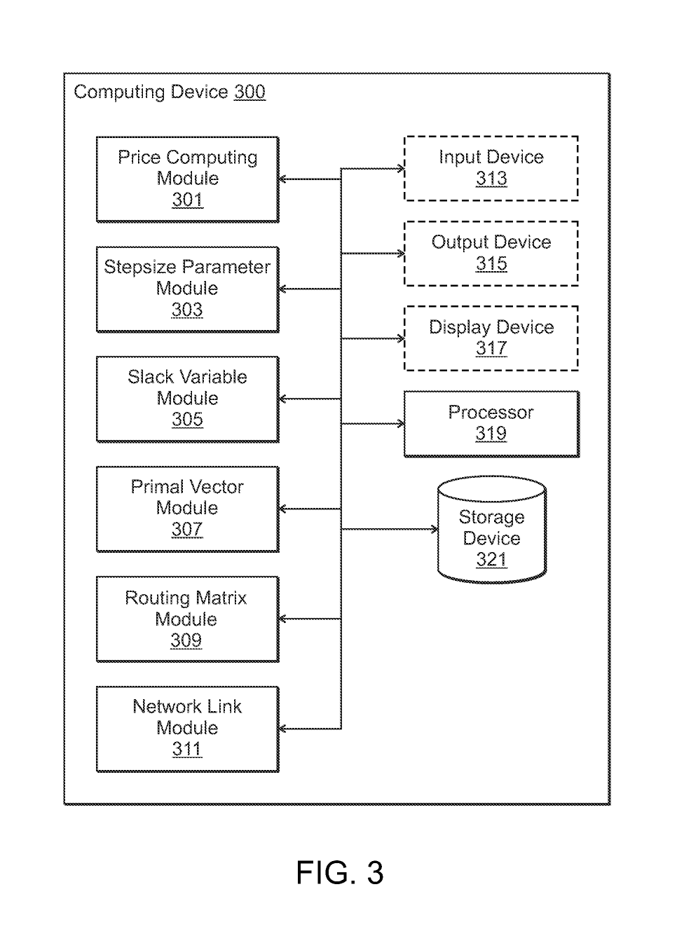

By the diagonal structure of the Hessian matrix H_{K}, the scalars (Δ\tilde{x}ᵢ^{k})²(Hₖ)ᵢᵢ and (Δ\tilde{x}_{l+S}^{k})²(Hₖ)_{(l+S)(l+S)} are available to the corresponding source i and link l respectively, hence z*ᵢ and y*ᵢ can be computed using local information. In the above process, each source only uses aggregate information along its route L*(i)⊂L(i) and each link l only uses information from sources i∈Θₜ⊂S(l). The evolution of the distributed summation procedure for the sample network in FIG. 3 is shown in FIGS. 5 and 6.

The following two lemmas quantify the expansion of the t-hop neighborhood in the auxiliary graph for the links and sources. For each source i, [symbol] (l) is used to denote the set of nodes that are connected to node i by a path of length at most t in the auxiliary graph. Note that [symbol] ᵢ(0)−{i}. Node i is t-hops away from node j, where t is the length of the shortest path between nodes i and j.

Lemma 4.9:

Consider a network and its auxiliary graph with sets {Θᵢ}_{l∈L}. For any link l and all t≧1:

[symbol]

ᵢ(t)∩ [symbol] ⱼ(t)=∪_{m∈Θ}_{ₜ} [symbol] ₘ(t−1) for i, j∈Θₗ with i≠j. (52)

Since the source nodes i, j∈Θₗ, by part (2) of Lemma 4.8, they are 1-hop away from all other nodes in Θₗ. Hence if a source node n is in [symbol] ₘ(l−1) for m∈θₗ, then n is at most t-hops away from i or j. This yields

∪_{m∈Θ}_{ₗ} [symbol] ₘ(t−1)⊂ [symbol] ᵢ(t)∩ [symbol] ⱼ(t). (63)

On the other hand, if n∈ [symbol] ᵢ(t)∩ [symbol] ⱼ(t), then either n∈ [symbol] ᵢ(t−1) and hence n∈∪_{m∈Θ}_{ₗ} [symbol] ₘ(t−1) or n∈( [symbol] ᵢ(t) [symbol] ᵢ(t−1))∩ [symbol] ⱼ(t).

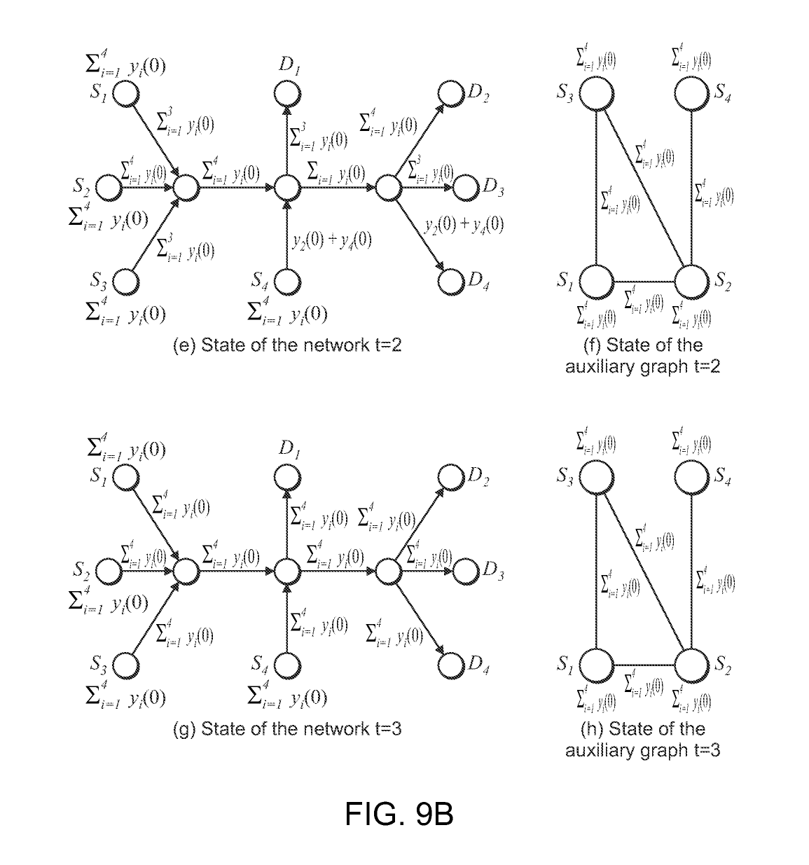

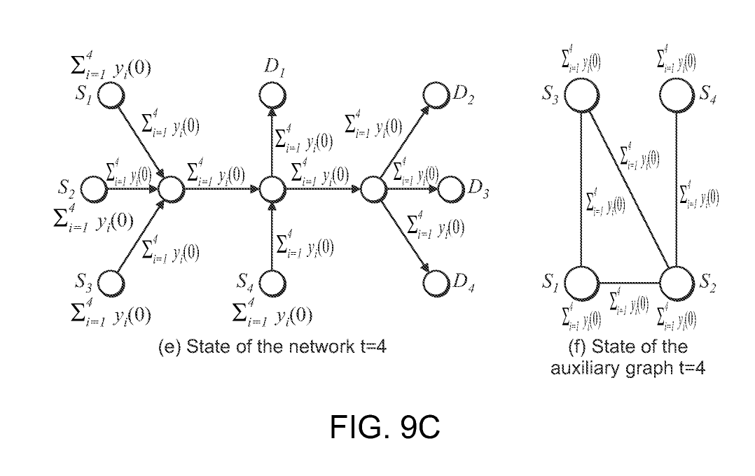

Let P(a, b) denote an ordered set of nodes on the path between nodes a and b including b but not a for notational convenience. Then the above relation implies there exists a path, illustrated in FIGS. 9A-9C:

|P(i,n)|=t and |P(j,n)|≦t. Let n*∈P(i,n)∩P(j,n) and P(j,n*)∩P(j,n*)=.

The node n*exists, because the two paths both end at n. If n*∉Θₗ, then a cycle of (P(i, n*), P(n*, j), P(j, i)) results, which includes an edge with label Lₗ between i and j and other edges. In view of part (6) of Lemma 4.8, this leads to a contradiction. Therefore n*∈Θₗ is obtained, implying P(i, n)={P(i, n*), P(n*, n)}. Since i is connected to all nodes in Θₗ, |P(i,n*)|=1 and hence |P(n*,n)|=t−1, which implies n∈N_{n*}(t−1)⊂∪ₘ_{_{∈}}_{θ}_{ₗ}Nₘ(t−1). Therefore the above analysis yields

[symbol]

ᵢ(t)∩ [symbol] ⱼ(t)⊂∪_{m∈Θ}_{ₗ} [symbol] ₘ(t−1).

With relation (53), this establishes the desired equality.

Lemma 4.10:

If a network and its auxiliary graph have sets {Θₗ}ₗ_{_{∈L}}, then for any source i, and all t≧1:

(∪_{j∈Θ}_{ₗ} [symbol] ⱼ(t))∩(∪_{j∈Θ}_{ₘ} [symbol] ⱼ(t))= [symbol] (t) for Lm∈L*(i) with l≠m. (54)

Since l, m∈L*(i), i∈Θₗ and i∈Θₘ, this yields,

[symbol]

ᵢ(t)⊂(∪ [symbol] Θ [symbol] [symbol] (t))∩(∪ [symbol] Θ_{ₘ} [symbol] [symbol] (t)).

On the other hand, assuming there exists a node n with n∈(∪_{j∈Θ}_{ₗ} [symbol] ⱼ(l))∩(∪_{j∈Θ}_{ₘ} [symbol] (l) ∩(∪_{j∈Θ}_{ₘ} [symbol] ⱼ(l)), and n∉ [symbol] ᵢ(l). Then there exists a node p∈Θₗ with p≠i and n∈ [symbol] ₚ(l). Similarly there exists a node q∈Θₘ with q≠i and n∈ [symbol] _{q}(t). Let P(a, b) denote an ordered set nodes on the path between nodes a and b including b but not a for notational convenience. Let n*∈P(p,n)∩P(q,n) and P(p, n*)∩P(q, n*)=. The node n* exists, because the two paths both end at n. Since nodes i, p are connected via an edge with label Lₗ and i, q are connected via an edge with label Lₘ, a cycle of {P(i, p), P(p, n), P (m, q), P(q, i)} exists, which contradicts part (6) in Lemma 4.8 providing

(∪_{j∈Θ} [symbol] [symbol] [symbol] (t))∩(∪_{j∈Θ} [symbol] [symbol] [symbol] (t))⊂ [symbol] ᵢ(t).

The preceding two relations establish the desired equivalence.

Upon termination of the summation procedure, each source i and link l have yᵢ(S)=zₗ(S−1)=\tilde{λ}(x^{k}))² [cf. Eq. (48)].

### Theorem 4.11.

Consider a network and its auxiliary graph with sets {Θ [symbol] }_{l∈L}. Let Ω denote the set of all subsets of S and define the function σ: Ω→R as

$$σ ( K ) = \text{?} + {\sum }_{i ∈ K} {y}_{i}^{*} , \\ \text{?} \text{indicates text missing or illegible when filed}$$

where y*ᵢ=(Δ\tilde{x}ᵢ^{k})²(Hₖ)ᵢᵢ,

$$\text{?} = \text{?} {( Δ \text{?} )}^{2} ( {H}_{k} ) \text{?}$$

$$\text{?} \text{indicates text missing or illegible when filed}$$

and l_{{l∈L(i)} is the indicator function for the event {l∈L(i)}. Let y}ᵢ(t) and zₗ(t) be the iterates generated by the distributed summation procedure described above. Then for all t ∈{1, . . . S}. the value zₗ(t) at each link satisfies

zₗ(t)=σ(∪ [symbol] Θ [symbol] [symbol] ᵢ(t−1)). (55)

and the value [symbol] ᵢ(t) at each source node satisfies

yᵢ(t)=σ [symbol] ᵢ(t)). (56)

For base case: t=1:

Since zᵢ(0)=0 for all links, Eq. (50) for t=1 is

$${z}_{i} ( 1 ) = {\sum }_{i ∈ {Θ}_{t}} {y}_{i} ( 0 ) = {\sum }_{i ∈ {Θ}_{t}} ( {y}_{i}^{*} + {\sum }_{i ∈ L ( i )} {y}_{i}^{*} ) = σ ( \text{?} ) , \\ \text{?} \text{indicates text missing or illegible when filed}$$

where the definition of y(0) [cf. Eq. (49)] and the function σ(•). Since [symbol] ᵢ(0)=i, the above relation implies Eq. (55) holds.
For source i, from update relation (51):

$${y}_{i} ( 1 ) = {\sum }_{i ∈ {L}^{*} ( i )} σ ( {Θ}_{i} ) - ( \vert {L}^{*} ( i ) \vert - 1 ) {y}_{i} ( 0 ) .$$

Lemma 4.10 and inclusion-exclusion principle imply

$${\sum }_{i ∈ {L}^{*} ( i )} σ ( {Θ}_{i} ) = σ ( \text{?} {Θ}_{i} ) + ( \vert {L}^{*} ( i ) \vert - 1 ) σ ( i ) . \\ \text{?} \text{indicates text missing or illegible when filed}$$

Since yᵢ(t))=σ(i) based on the definition of yᵢ(0) [cf. Eq. (49)], by rearranging the preceding two relations it may be shown that:

yᵢ(1)=σ(∪_{l∈L*(i)}Θₗ)=σ( [symbol] ᵢ(1)),

which shows Eq. (56) holds for t=1.

For t=T≧2.

Assuming t=T−1, Eqs. (56) and (55) hold. When t=T, by update equation (50), for link l:

$$\begin{matrix}{z}_{i} ( T ) = {\sum }_{i ∈ {Θ}_{t}} {y}_{i} ( T - 1 ) - ( \vert {Θ}_{i} \vert - 1 ) {z}_{i} ( T - 1 ) \\ = {\sum }_{i ∈ {Θ}_{t}} σ ( {𝒩}_{i} ( T - 1 ) ) - ( \vert {Θ}_{i} \vert - 1 ) {z}_{i} ( T - 1 ) ,\end{matrix}$$

where the second equality follows from Eq. (56) for t=T−1

If |Θₗ|=1, then zₗ(T)=σ [symbol] ᵢ(T−1)), for i∈Θₗ, therefore Eq. (55) is satisfied.

For |Θₗ|>1. using Lemma 4.9 for t=T and by inclusion-exclusion principle,

$${\sum }_{i ∈ {Θ}_{t}} σ ( {𝒩}_{i} ( T - 1 ) ) - σ ( \text{?} {𝒩}_{i} ( T - 1 ) ) + ( \vert {Θ}_{i} \vert - 1 ) σ ( {⋃}_{m ∈ {Θ}_{i}} {𝒩}_{m} ( T - 2 ) ) . \\ \text{?} \text{indicates text missing or illegible when filed}$$

Eq. (55) for t=T−1 yields zₗ(T−1)=σ(∪_{m∈Θ} [symbol] ₘ(T−2)). By using this fact and rearranging the preceding two relations, Eq. (55) holds for t=T, i.e.,

zₗ(T)=σ(∪_{i∈Θ} [symbol] [symbol] ᵢ(T−1)).

From Eq. (51), using the preceding relation:

$${y}_{i} ( T ) = \text{?} ( T ) - ( \vert {L}^{*} ( i ) \vert - 1 ) {y}_{i} ( T - 1 ) \text{?} σ ( \text{?} {𝒩}_{i} ( T - 1 ) ) - ( \vert {L}^{*} ( i ) \vert - 1 ) {y}_{i} ( T - 1 ) . \\ \text{?} \text{indicates text missing or illegible when filed}$$

Lemma 4.10 and inclusion-exclusion principle imply

$$\text{?} σ ( \text{?} {𝒩}_{i} ( T - 1 ) ) - σ ( \text{?} {𝒩}_{i} ( T - 1 ) ) \text{?} ( \vert {L}^{*} ( i ) \vert - 1 ) σ ( {𝒩}_{i} ( T - 1 ) ) . \\ \text{?} \text{indicates text missing or illegible when filed}$$

By definition of [symbol] ᵢ(∩) ∪_{l∈L*(i)}∪_{i∈Θ} [symbol] [symbol] ᵢ(T−1)= [symbol] ᵢ(T). By using Eq. (56) for t=T−1, i.e., yᵢ(T−1)=σ(Nᵢ(T−1)) and rearranging the above two equations,

y(T)=σ( [symbol] ᵢ(T)).

which completes the inductive step.

Using definition of the function σ(•): (\tilde{λ}(x^{k})) [symbol] σ(S). By the above theorem, it is shown that after S iterations,

y [symbol] (S)=σ( [symbol] ᵢ(S))=σ(S)=(\tilde{λ}(x^{k}))².

By observing that ∪_{i∈Θ} [symbol] [symbol] (S−1)=S, it is also shown that

[symbol]

(S−1)=σ(∪_{i∈Θ}_{ᵢ} [symbol] ᵢ(S−1))=σ(S))=(\tilde{λ}(x^{k}))²,

obtained using part (5) of Lemma 4.8. This shows that the value \tilde{λ}(x^{k})² is available to all sources and links after S−1 iterations.

Note that the number S is an upper bound on the number of iterations required in the distributed summation process to obtain the correct value at the links and sources in the original graph. If the value of the diameter of the auxiliary graph (or an upper bound on it) is known, then the process may, in various embodiments, terminate in number of steps equal to this value plus 1. For instance, in embodiments where all the sources share one common link, the auxiliary graph is a complete graph, and only 2 iterations are required. In contrast, when the auxiliary graph is a line, the summation procedure would take S iterations.

In contrast to other methodologies (e.g., spanning tree methods), our summation procedure involves (scalar) information aggregated along the routes and fed back independently to different sources, which is a more natural exchange mechanism in an environment with decentralized sources. Moreover, processors in the system (i.e., sources and links) do not need to maintain predecessor/successor information (as required by spanning tree methods). The only required network-related information for various embodiments is the sets Θₗ for l∈L kept at the individual links and obtained from the auxiliary graph, which is itself constructed using the feedback mechanism described herein above.

### Strict Feasibility of Primal Iterates

When starting with a strictly positive primal vector x^{o} and using the stepsize given in (47), all the primal iterates generated by the inexact Newton algorithm remain strictly positive. Such conditions are necessary to ensure that the algorithm is well defined. By using the slack variable definitions, it is implied that the source rates generated by the inexact Newton algorithm (i.e., the first S components of x^{k}) do not violate capacity constraints throughout the algorithm.

Theorem 4.12.

Given a strictly positive feasible primal vector x^{o}, let {x^{k}} be the sequence generated by the inexact distributed Newton method (28) for problem (4) with μ≧1. Assuming that the stepsize d^{K} is selected according to Eq. (47) for some positive scalar V with 0<V<0.267. Then, the primal vector x^{K} is strictly positive, i.e., x^{k}>0, for all k.

A base case of x^{o}>0 holds by the assumption of the theorem. Since the Uᵢ are strictly concave [cf. Assumption 1], for any x^{k}:

$$\text{?} ( {x}_{i}^{k} ) \geq 0.$$

$$\text{?} \text{indicates text missing or illegible when filed}$$

Given the form of the Hessian matrix [cf. Eq. (11)], this implies

$${( {H}_{k} )}_{ii} \geq \frac{μ}{{( {x}_{i}^{k} )}^{2}}$$

for all i, and therefore

$$\text{?} ( {x}^{k} ) = {( \text{?} {( Δ \text{?} )}^{2} {( {H}_{k} )}_{ii} )}^{\frac{1}{2}} \geq {( \text{?} {μ ( \frac{Δ {\tilde{x}}_{i}^{k}}{{x}_{i}^{k}} )}^{2} )}^{\frac{1}{2}} \geq max ; \vert \frac{\sqrt{μ} Δ {\tilde{x}}_{i}^{k}}{{x}_{i}^{k}} \vert , \\ \text{?} \text{indicates text missing or illegible when filed}$$

where the last inequality follows from the non-negativity of the terms

$$\text{?} {μ ( \frac{Δ {\tilde{x}}_{i}^{k}}{{x}_{i}^{k}} )}^{2} . \\ \text{?} \text{indicates text missing or illegible when filed}$$

By taking the reciprocal on both sides, the above relation implies

$$\frac{1}{\tilde{λ} ( {x}^{k} )} \leq \frac{1}{{max}_{i} \vert \frac{\sqrt{μ} Δ {\tilde{x}}_{i}^{k}}{{x}_{i}^{k}} \vert} = \frac{1}{\sqrt{μ}} {min}_{i} \vert \frac{{x}_{i}^{k}}{Δ {\tilde{x}}_{i}^{k}} \vert \leq {min}_{i} \vert \frac{{x}_{i}^{k}}{Δ {\tilde{x}}_{i}^{k}} \vert , \qquad ( 57 )$$

where the last inequality follows from the fact that μ≧1.

Case i: \tilde{λ}(x^{k})≧V

The stepsize choice d^{k} [cf. Eq. (47)] satisfies

d^{k}=1/(1+\tilde{λ}(x^{k}))<1/\tilde{λ}(x^{k}).

Using Eq. (57), this implies

$${d}^{k} < min , \vert \frac{{x}_{i}^{k}}{Δ {\tilde{x}}_{i}^{k}} \vert .$$

Hence if x^{k}>0, then x^{k+1}=x^{k}+d^{k}Δ\tilde{x}^{k}>0.

Case ii: \tilde{λ}(x^{k})<V

Since 0<V<0.267, \tilde{λ}(x^{k})<V≦1. Hence

$${d}^{k} - 1 < \frac{1}{\tilde{λ} ( {x}^{k} )} \leq {min}_{i} \vert \frac{{x}_{i}^{k}}{Δ {\tilde{x}}_{i}^{k}} \vert ,$$

where the last inequality follows from Eq. (57). Once again, if x^{k}>0, then x^{k+1}=x^{k}+d^{k}Δ\tilde{x}^{k}>0.

In both cases x^{k+1}=x^{k}+

hence the distributed inexact Newton update is well defined throughout the algorithm and the algorithm achieves a superlinear convergence rate in terms of primal iterations to error neighborhood with sufficiently small error parameters ρ and ∈.

Convergence in Dual Iterations
The rate of convergence of the dual iterations is given by ∥w(t)−w*∥₂≦|λ₁|^{t}α, where w* is the limit, α is some constant related to initialization, and λ₁=ρ((Dₖ+ B̅ₖ)⁻¹( B̅ₖ−Bₖ)).
The matrix (Dₖ+ B̅ₖ)⁻¹( B̅ₖ−Bₖ) can be viewed as the graph Laplacian of the weighted dual graph, where the nodes are the links in the original graph and the weight Wᵢⱼ between link i and j is given by

$${W}_{ij} = {( {D}_{k} + {\overline{B}}_{k} )}_{ii}^{- 1} {B}_{ij} = {( {D}_{k} + {\overline{B}}_{k} )}_{ii}^{- 1} {\sum }_{s ∈ S ( {L}_{i} ) ⋃ S ( {L}_{j} )} {H}_{ss} .$$

Convergence in Dual Iteration—Finite Termination
Denote D̅ₖ=Dₖ+ B̅ₖ and Mₖ=(Dₖ+ B̅ₖ)⁻¹( B̅ₖ−Bₖ).
Mₖ has D̅ₖ-conjugate eigenvectors yᵢ:

y′ᵢ D̅ₖyⱼ=0 i≠j, y′ᵢ D̅ₖyᵢ=1 for all i.
D̅ₖ induced operator norm of Mₖ:

$${‖ {M}_{k} ‖}_{{\overline{D}}_{k}} = {λ}_{1} \leq 1 - \frac{{min}_{j ∈ ℒ ⋃ S} {( {H}_{k}^{- 1} )}_{jj}}{{max}_{i ∈ ℒ} {( {D}_{k} + {\overline{B}}_{k} )}_{ii}} < 1 for all k .$$

### Theorem

For any k, assume the dual vector w^{k} is obtained by implementing the dud iteration (3) Nₖ steps, where

$${N}^{k} \geq \frac{1}{log ( {\overline{ρ}}^{k} )} log ( \frac{( 1 - {\overline{ρ}}^{k} ) {β}^{k} {\hat{d}}^{k}}{\sqrt{L} {‖ \text{?} {AH}_{k}^{- 1} ∇ f ( {x}^{k} ) ‖}_{∞}} ) , \\ \text{?} \text{indicates text missing or illegible when filed}$$

then ∥w(N^{k})−w*∥_{∞}≦β^{k} and the error in the resulting Newton direction γ^{k}=Δx^{k}−Δ\tilde{x}^{k} satisfies |(γ^{k})′∇²ƒ(x^{k})γ^{k}|≦p²(Δ\tilde{x}^{k})′∇²ƒ(x^{k})Δ\tilde{x}^{k}+∈, where scalars ρ̅^{k}, β^{k} and \hat{d}^{k} can be computed in a distributed way.

### Convergence in Primal Iteration—Damped Convergent Phase

Two sources of error: in computation of the (primal) Newton direction, and in computation of the (inexact) Newton decrement.

### Assumption

Denote the error in computation of the Newton direction, i.e., Δx^{k}=Δ\tilde{x}^{k}+γ^{k}. Then |(γ^{k})′∇²ƒ(x^{k})(γ^{k})|≦p²(Δ x̅^{k})′∇²ƒ(x^{k})Δ\tilde{x}^{k}+∈ for some positive scalars p<1 and ∈. Denote the error in computation of the Newton decrement calculation as τ^{k}. i.e. τ^{k}=\tilde{λ}(x^{k})−θ^{k}, then for all k, τ^{k} satisfies

$$\vert \text{?} \vert \leq ( \frac{1}{b} - 1 ) ( 1 + V ) . \\ \text{?} \text{indicates text missing or illegible when filed}$$

The above assumption can be verified in a distributed manner.
Under the above assumption, we have for θ^{k}≧V, improvement in the objective function is lower bounded by a constant:

$$f ( {x}^{k + 1} ) - f ( {x}^{k} ) \leq - ( 2 b - 1 ) a ( 1 + p ) {( \frac{2 Vb - V + b - 1}{b} )}^{2} / ( 1 + \frac{2 Vb - V + b - 1}{b} ) .$$

### Convergence in Primal Iteration—Quadratically Convergent Phase

### Theorem

Let {xₖ} be a sequence generated by our inexact distributed Newton algorithm. Let θ^{k}<V for some k>0. Then, for all m>0, we have

$$f ( {x}^{\overline{k} + m} ) - {f}^{*} \leq \frac{1}{{2}^{{2}^{m}} v} + ξ + \frac{δ}{v} \frac{{2}^{{2}^{m}} - 1}{{2}^{{2}^{m}}} , and$$

$${limsup}_{m \to ∞} f ( {x}^{\overline{k} + m} ) - {f}^{*} \leq ξ + \frac{δ}{2 v} .$$

where ξ, ν, δ are constants that depend on the error levels introduced before.
In the quadratic convergence phase (i.e. when θ [symbol] <V and therefore d^{k}=1 for all k≧ k̅), the exact Newton decrement converges superlinearly to an error neighborhood.
   Convergence with Respect to Design Parameter μ

### Theorem

For the equality constrained optimization problem and a given denote the optimal solution as x(μ), and h(x(μ))=Σᵢ₋₁^{S}−Uᵢ(xᵢ(μ)). Similarly, denote the optimal solution for the inequality constrained problem as x*, and h*=Σ_{i=S}−Uᵢ(xᵢ*). Then the following relation holds,

h(x(u))−h*<u.

[symbol]

Execute the algorithm twice to achieve a desired relative accuracy level a.
   First time: with some arbitrary μ, and obtain a sequence of x^{k} converging to some x(μ).
   Let M=(a[h(x(μ))−])⁻¹.
   Second time: minimize −MΣᵢ₌₁^{s} Uᵢ(xᵢ)−Σᵢ₌₁^{S+L} log(xᵢ), subject to link capacity constraints. We obtain a sequence of \tilde{x}^{k} converges to some \tilde{x}(1).
   The above theorem implies

$$\frac{h ( \overline{x} ( 1 ) ) - {h}^{*}}{{h}^{*}} \leq a .$$

### Simulation Results

Simulation results demonstrate that the decentralized Newton methods described herein demonstrate significant improvement over existing methods in terms of number of iterations. For this simulation, error tolerance levels of p=10⁻³, ∈=10⁻⁴ [cf. Assumption 2] were used, and when \tilde{λ}(x^{k})<V=0.12 the stepsize choice was switched to be d^{k}=1 for all [symbol] k≧ [symbol] k. With such error tolerance levels, all the conditions necessary for achieving a local quadratic rate of convergence were satisfied. A distributed inexact Newton method in accordance with various embodiments was implemented twice with different barrier coefficients; and a proper selection of the barrier coefficient (together with a scaling of objective function) guarantees the resulting objective function value to be within 1% of the optimal value of problem (2). For a comprehensive comparison, both the primal and dual iterations were implemented through distributed error checking methods as described in 4.4. In particular, as described below, the number of iterations refers to the sum of dual iterations at each of the generated primal iterates. In the simulation results, performance of a distributed inexact Newton method in accordance with various embodiments was compared against both a subgradient method and a Newton-type diagonal scaling dual method developed. Both methods were implemented using a constant stepsize to can guarantee convergence.

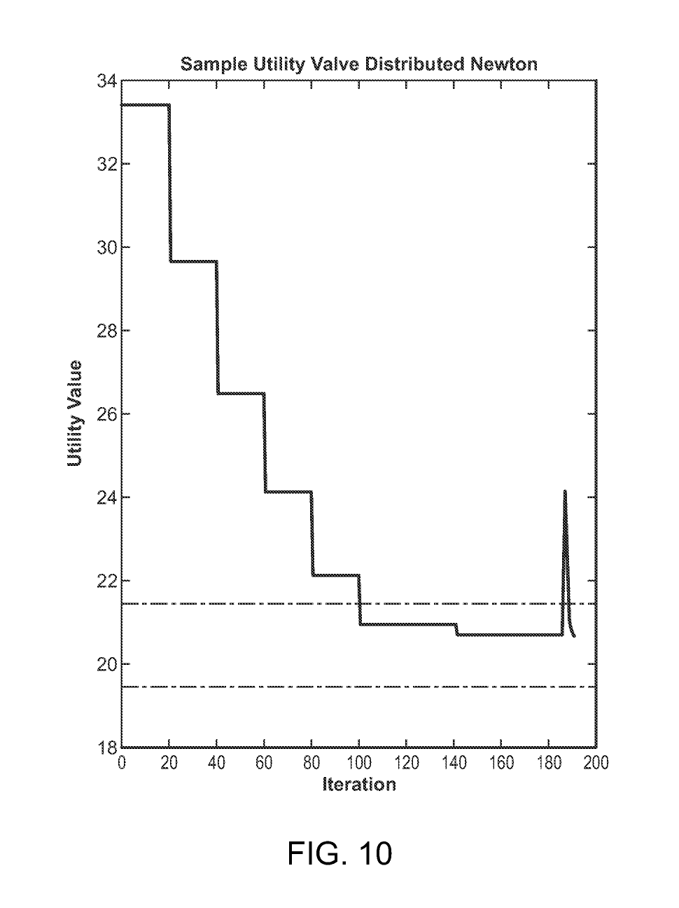

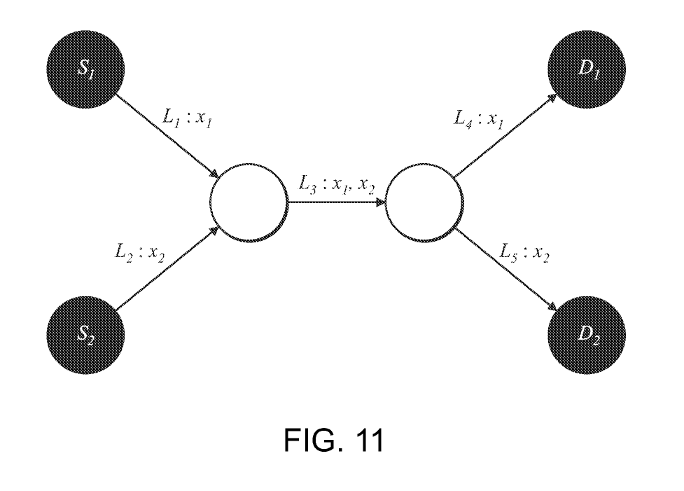

FIG. 10 presents a sample evolution of an objective function value when the distributed inexact Newton method is applied to a simple network shown in FIG. 11. The horizontal line segments correspond to the dual iterations, where the primal vector stays constant, and each jump in the figure is a primal Newton update. The spike to the right of the figure is the result of resealing and using a new barrier coefficient in the second round of the distributed inexact Newton algorithm. The black dotted lines indicate a ±5% interval around the optimal objective function value.

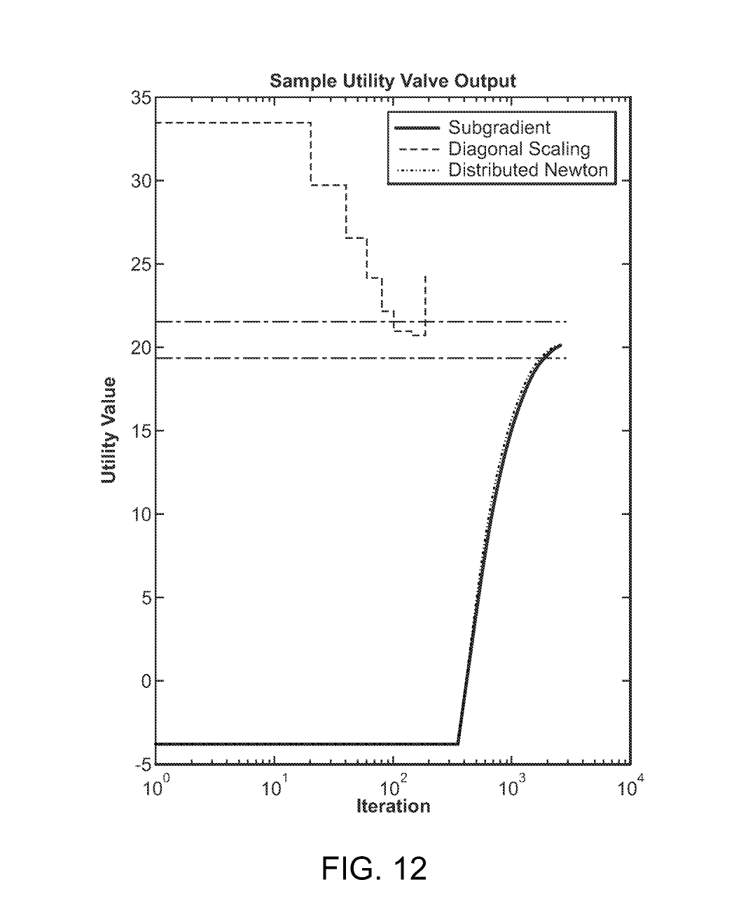

The other two methods were implemented for the same problem, and the objective function values are plotted in FIG. 12, with logarithmic scaled iteration count on the T-axis. Black dotted lines indicate a ±5% interval around the optimal objective function value. While the subgradient and diagonal scaling methods have similar convergence behavior, the distributed inexact Newton method significantly outperforms the two.

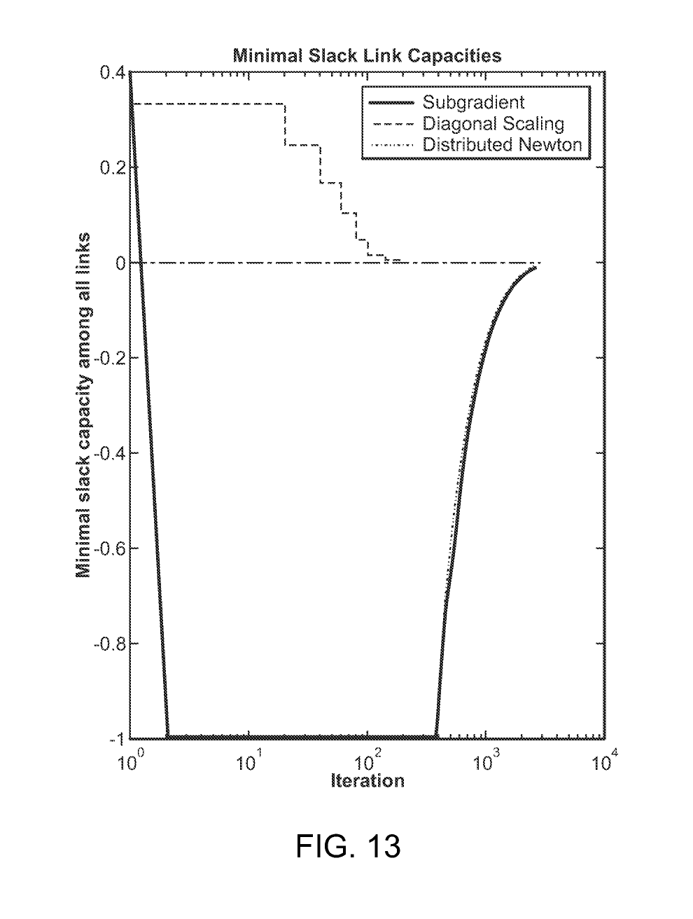

One of the important features of the distributed inexact Newton method is that, unlike the other two methods, the generated primal iterates satisfy the link capacity constraint throughout the method. This observation is confirmed by FIG. 13, where the minimal slacks in links are shown for all three methods. The black dotted line is the zero line and a negative slack means violating the capacity constraint. The slacks that the distributed inexact Newton method yields always stay above the zero line, while the other two only become feasible in the end.

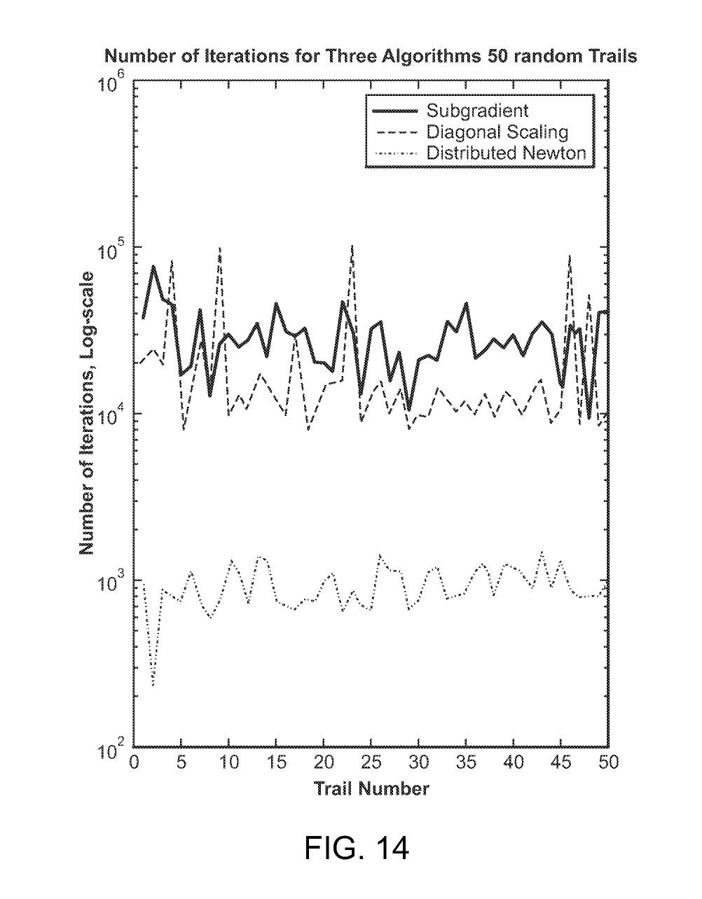

To test the performances of the methods over general networks, 50 random networks were generated, with a number of links L=1.5 and a number of sources S=8. Each routing matrix consisted of L×R Bernoulli random variables. All three methods were implemented over the 50 networks. The number of iterations upon termination for all 3 methods was recorded and results are shown in FIG. 14 on a log scale. The mean number of iterations to convergence from the 50 trials was 924 for a distributed inexact Newton method, 20,286 for a Newton-type diagonal scaling method, and 29,315 for a subgradient method.

FIG. 3 is a block diagram of an exemplary computing device 300. The modules and/or components of the computing device 300 can function as described herein. The input device 313, the output device 315, and the display device 317 are optional components of the computing device 300. In some examples, the computing device 300 can include some or all of the modules/devices as described herein. The modules and devices described herein can, for example, utilize the processor 319 to execute computer executable instructions and/or one or more modules can each include their own processor 319 to execute computer executable instructions (e.g., an encryption processing unit, a field programmable gate array processing unit, etc.). It should be understood that the computing device 300 can include, for example, other modules, devices, and/or processors known in the art and/or varieties of the illustrated modules, devices, and/or processors.

The input device 313 receives information (e.g., instructions) associated with the computing device 300 from a user (not shown) and/or another computing system (not shown). The input device 313 can include, for example, a keyboard, a scanner, etc. The output device outputs information associated with the computing device (e.g., information to a printer (not shown), information to a speaker, etc.).

The display device 317 displays information associated with the computing device (e.g., link information, weight information, etc.). The processor 319 executes the operating system and/or any other computer executable instructions for the computing device 300 (e.g., executes applications, etc.).

The storage device 321 stores link information, network route information, and/or optimized source rates. The storage device 321 can store information and/or any other data associated with the computing device 300. The storage device 321 can include a plurality of storage devices 321 and/or the computing device 300 can include a plurality of storage devices 321 (e.g., a link storage device, a network route storage device, etc.). The storage device 321 can include, for example, long-term storage (e.g., a hard drive, a tape storage device, flash memory, etc.), short-term storage (e.g., a random access memory, a graphics memory, etc.), and/or any other type of computer readable storage.

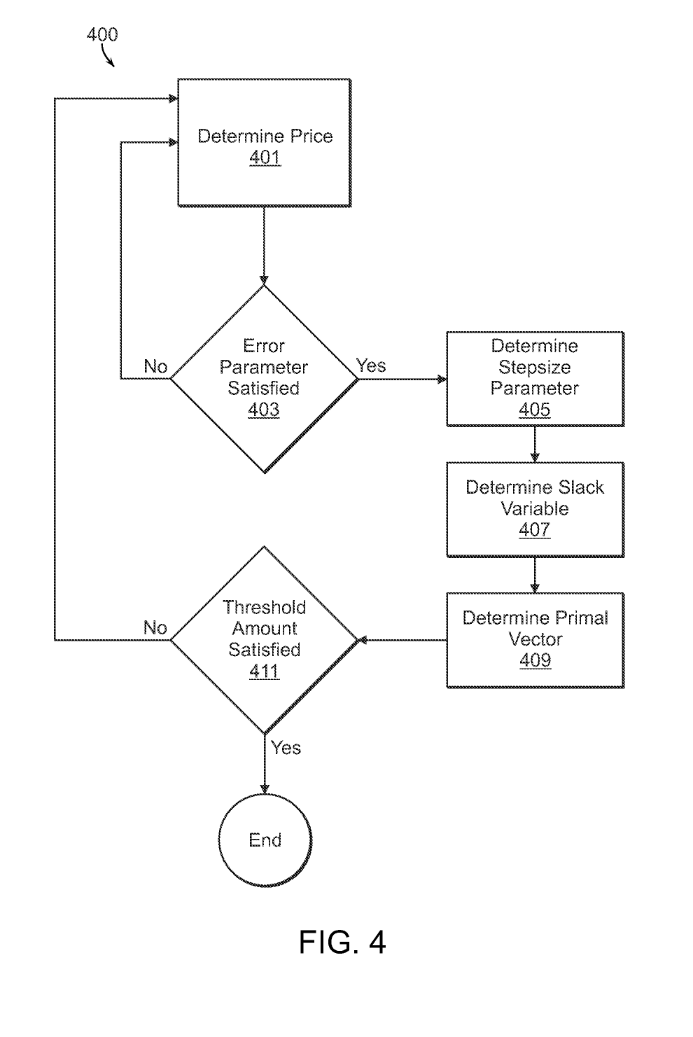

FIG. 4 is a flowchart of an exemplary network utility maximization process utilizing, for example, the computing device of FIG. 3.

In some examples, the technology includes a network utility maximization method 400. The method 400 includes (a) determining a price for one or more links 401; (b) repeating step (a) based on an error parameter 403 and an aggregated weighed price; (c) determining a stepsize parameter 405 based on a diagonal matrix and weighted prices; (d) determining a slack variable 407 based on the aggregated weighted price; (e) determining a primal vector 409 based on the aggregated weighted price, the stepsize parameter, and the slack variable; (f) repeating steps (a) through (e) based on a threshold amount 411 and the primal vector.

In other examples, the primal vector is indicative of optimal source rates for a destination computing device and a source computing device.

In some examples, a destination computing device processes steps (a), (b), (c), (d), (e), and (f) for source rates.

In other examples, a plurality of destination computing devices process steps (a), (b), (c), (d), (e), and (f) for each respective source rates associated with the respective destination computing device.

In some examples, the primal vector is determined utilizing a second-order function.

In other examples, step (a) further includes (a-1) separating routing Hessian related matrix into a plurality of parts; and (a-2) determining the link price based on the Hessian related matrix.

In some examples, step (a) further includes (a-1) receiving link price information from each link in a network route; and (a-2) determining the aggregated weighted price for the network route.

In some examples, the technology includes a computer program product tangibly embodied in an information carrier. The computer program product includes instructions being operable to cause an information processing apparatus to perform any of the steps described herein.

In other examples, the technology includes a network utility maximization system. The system includes a plurality of computing devices and each computing device can be a destination node, a source node, a link, or any combination thereof. Each computing device includes a network utility maximization function module (price computing module) 301 configured to determine a price for one or more links, and repeat the determination of the price based on an error parameter and an aggregated weighed price. Each computing device further includes a stepsize parameter module 303 configured to determine a stepsize parameter based on a diagonal matrix and weighted prices. Each computing device further includes a slack variable module 305 configured to determine a slack variable based on the aggregated weighted price. Each computing device further includes a primal vector module 307 configured to determine a primal vector based on the aggregated weighted price, the stepsize parameter, the slack variable, and a threshold amount.

In some examples, the primal vector is indicative of optimal source rates for a destination computing device and a source computing device.

In other examples, the primal vector is determined utilizing a second-order function.

In some examples, each computing device further includes a routing matrix module 309 configured to separate a Hessian related into a plurality of parts; and determine the link price based on the Hessian related matrix.

In other examples, each computing device further includes a network link module 311 configured to receive link price information from each link in a network route; and determine the aggregated weighted price for the network route.

The above-described systems and methods can be implemented in digital electronic circuitry, in computer hardware, firmware, and/or software. The implementation can be as a computer program product. The implementation can, for example, be in a machine-readable storage device, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by and an apparatus can be implemented as special purpose logic circuitry. The circuitry can, for example, be a FPGA (field programmable gate array) and/or an ASIC (application-specific integrated circuit). Subroutines and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be feedback provided to the user in any form of sensory feedback (e.g., visual feedback, auditory feedback, or tactile feedback). Input from the user can, for example, be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

The transmitting device can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a Blackberry®.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A network utility maximization method, executable on one or more processors, comprising:
(a) determining, using the one or more processors, a price for one or more links;
(b) repeating step (a), using the one or more processors, based on an error parameter and an aggregated weighed price;
(c) determining, using the one or more processors, a stepsize parameter based on a diagonal matrix and weighted prices;
(d) determining, using the one or more processors, a slack variable based on the aggregated weighted price;
(e) determining, using the one or more processors, a primal vector based on the aggregated weighted price, the stepsize parameter, and the slack variable;
(f) repeating, using the one or more processors, steps (a) through (e) based on a threshold amount and the primal vector.

2. The method of claim 1, wherein the primal vector is indicative of an optimal source rates for a destination computing device and a source computing device.

3. The method of claim 1, wherein a destination computing device processes steps (a), (b), (c), (d), (e), and (f) for source rates.

4. The method of claim 1, wherein a plurality of destination computing devices process steps (a), (b), (c), (d), (e), and (f) for each respective source rate associated with the respective destination computing device.

5. The method of claim 1, wherein the primal vector is determined utilizing a second-order function.

6. The method of claim 1, wherein step (a) further comprises:
(a-1) separating a Hessian related matrix into a plurality of parts; and
(a-2) determining the link price based on the Hessian related matrix.

7. The method of claim 1, wherein step (a) further comprises:
(a-1) receiving link price information from each link in a network route; and
(a-2) determining the aggregated weighted price for the network route.

8. A computer program product tangibly embodied in an information carrier for performing a method comprising:
(a) determining a price for one or more links;
(b) repeating step (a) based on an error parameter and an aggregated weighed price;
(c) determining a stepsize parameter based on a diagonal matrix and weighted prices;
(d) determining a slack variable based on the aggregated weighted price;
(e) determining a primal vector based on the aggregated weighted price, the stepsize parameter, and the slack variable;
(f) repeating steps (a) through (e) based on a threshold amount and the primal vector.

9. A network utility maximization system, comprising:
a plurality of computing devices, each computing device being a destination node, a source node, a link, or any combination thereof, each computing device comprising:
a network utility maximization function module configured to:
determine a price for one or more links, and
repeat the determination of the price based on an error parameter and an aggregated weighed price;
a stepsize parameter module configured to determine a stepsize parameter based on a diagonal matrix and weighted prices;
a slack variable module configured to determine a slack variable based on the aggregated weighted price; and
a primal vector module configured to determine a primal vector based on the aggregated weighted price, the stepsize parameter, the slack variable, and a threshold amount.

10. The system of claim 9, wherein the primal vector is indicative of an optimal source rates for a destination computing device and a source computing device.

11. The system of claim 9, wherein the primal vector is determined utilizing a second-order function.

12. The system of claim 9, each computing device further comprising a routing matrix module configured to:
separate a Hessian related matrix into a plurality of parts; and
determine the link price based on the Hessian related matrix.

13. The system of claim 9, each computing device further comprising a network link module configured to:
receive link price information from each link in a network route; and
determine the aggregated weighted price for the network route.
